(19) United States
(12) Patent Application Publication
(10) Pub. No.: US 2011/0026894 A1
(43) Pub. Date: Feb. 3, 2011

(54) WALL-MOUNTED FIBER DISTRIBUTION HUB

(76) Inventors: Paula Rudenick, Eden Prairie, MN (US); Thomas G. LeBlanc, Westminster, MA (US); James J. Solheid, Lakeville, MN (US)

Correspondence Address: MERCHANT & GOULD PC, P.O. BOX 2903, MINNEAPOLIS, MN, 55402-0903, US

(21) Appl. No.: 12/829,118

(22) Filed: Jul. 1, 2010

Related U.S. Application Data
(60) Provisional application No. 61/222,342, filed on Jul. 1, 2009.

(51) Int. Cl. G02B 6/00

(52) U.S. Cl. 385/135; 385/137

(57) ABSTRACT

A fiber distribution hub defines at least one incoming cable port and at least one outgoing cable port. The fiber distribution hub includes a termination region, a splitter region, and a splice region. Some example hubs include a pass-through panel configured to manage a loop portion of a feeder cable. Some example hubs include a cable manager for managing distribution cables at the outgoing cable port. Some example hubs include pivotal splice tray stacks. Some example hubs include a swing frame on which the termination region and splitter region are positioned.

### CROSS-REFERENCES

This application claims priority from provisional application Ser. No. 61/222,342, filed Jul. 1, 2009, and which is incorporated herein by reference.

### BACKGROUND

Passive optical networks are becoming prevalent in part because service providers want to deliver high bandwidth communication capabilities to customers. Passive optical networks are a desirable choice for delivering high-speed communication data because they may not employ active electronic devices, such as amplifiers and repeaters, between a central office and a subscriber termination. The absence of active electronic devices may decrease network complexity and/or cost and may increase network reliability.

### SUMMARY

Certain aspects of the disclosure relate to fiber distribution hubs (FDHs) that provide an interface between a central office and subscribers. Certain aspects relate to features that enhance access to components within the FDHs. Other aspects relate to features that enhance cable management, ease of use, and scalability.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

FIG. 1 is a schematic representation of a network deploying passive fiber optic lines and including a central office that connects a number of end subscribers (also called end users herein) in a network in accordance with the principles of the present disclosure;

FIG. 2 is schematic diagram showing an example cable routing scheme for an example FDH in accordance with the principles of the present disclosure;

FIG. 3 is a front perspective view of an example FDH including a cover arranged in a closed position relative to a support in accordance with the principles of the present disclosure;

FIG. 4 is a rear perspective view of the example FDH shown in FIG. 3 in accordance with the principles of the present disclosure;

FIG. 5 is a front elevational view of the example FDH shown in FIG. 3 in accordance with the principles of the present disclosure;

FIG. 6 is a side elevational view of the example FDH shown in FIG. 3 in accordance with the principles of the present disclosure;

FIG. 7 is a top, front perspective view of a support of the FDH shown in FIG. 3 in accordance with the principles of the present disclosure;

FIG. 8 is a front elevational view of the support shown in FIG. 7 in accordance with the principles of the present disclosure;

FIGS. 9 and 10 are side elevational views of the support shown in FIG. 7 in accordance with the principles of the present disclosure;

FIG. 11 is a top plan view of the support shown in FIG. 7 in accordance with the principles of the present disclosure;

FIG. 12 is a top, front perspective view of a cover of the FDH shown in FIG. 3 in accordance with the principles of the present disclosure;

FIG. 13 is a front elevational view of the cover shown in FIG. 12 in accordance with the principles of the present disclosure;

FIG. 14 is a side elevational view of the cover shown in FIG. 12 in accordance with the principles of the present disclosure;

FIG. 15 is a rear elevational view of the cover shown in FIG. 12 in accordance with the principles of the present disclosure;

FIG. 15A is a partial view of a rear side of the cover shown in FIG. 12 in accordance with the principles of the present disclosure;

FIG. 15B is another partial view of the rear side of the cover shown in FIG. 12 in accordance with the principles of the present disclosure;

FIG. 16 is a side elevational view of the FDH shown in FIG. 3 with the cover arranged in a first open position to allow access to components mounted within the FDH in accordance with the principles of the present disclosure;

FIG. 17 is another side elevational view of the FDH shown in FIG. 16 with the cover arranged in a second open position in accordance with the principles of the present disclosure;

FIG. 18 is a front perspective view of a support frame suitable for mounting in the FDH shown in FIG. 3 in accordance with the principles of the present disclosure;

FIG. 19 is a front perspective view of a pass-through frame suitable for mounting in the FDH shown in FIG. 3 in accordance with the principles of the present disclosure;

FIG. 20 is a front elevational view of the pass-through frame shown in FIG. 19 in accordance with the principles of the present disclosure;

FIG. 21 is a top plan view of the pass-through frame shown in FIG. 20 in accordance with the principles of the present disclosure;

FIG. C is a detailed view of a portion of FIG. 21;

FIGS. 22 and 23 are front and rear perspective views, respectively, of a securement device suitable for use with the pass-through frame shown in FIG. 20 in accordance with the principles of the present disclosure;

FIG. 24 is a front elevational view of the securement device of FIGS. 22 and 23 in accordance with the principles of the present disclosure;

FIG. 25 is a partial, perspective view of an example FDH support to which a stub cable is secured in accordance with the principles of the present disclosure;

FIG. 25A is a top perspective view of an example sealing member for a pass-through cable configured in accordance with the principles of the present disclosure;

FIG. 26 is a partial, perspective view of an example FDH support to which a pass-through cable is secured in accordance with the principles of the present disclosure;

FIG. 27 is a partial view of an example FDH support to which a stub cable is being secured in accordance with the principles of the present disclosure;

FIG. 28 is a top perspective view of an example top-hat clamp suitable for securing a stub cable to the FDH support as shown in FIGS. 25 and 27 in accordance with the principles of the present disclosure;

FIG. 29 is a side elevational view of the top-hat clamp shown in FIG. 28 in accordance with the principles of the present disclosure;

FIG. 30 is a top plan view of the top-hat clamp shown in FIG. 28 in accordance with the principles of the present disclosure;

FIG. 31 is a front elevational view of the top-hat clamp shown in FIG. 28 in accordance with the principles of the present disclosure;

FIG. 32 is a front elevational view of the support frame of FIG. 18 in accordance with the principles of the present disclosure;

FIG. 33 is a top plan view of the support frame of FIG. 32 in accordance with the principles of the present disclosure;

FIGS. 34, 35, and B are side elevational views of the support frame of FIG. 32 in accordance with the principles of the present disclosure;

FIG. 36 is a rear perspective view of the support frame of FIG. 32 in accordance with the principles of the present disclosure;

FIG. 37 is a top, front perspective view of an example splice tray including a cover arranged in a closed position with respect to a base in accordance with the principles of the present disclosure;

FIG. 38 is a top, front perspective view of the example splice tray of

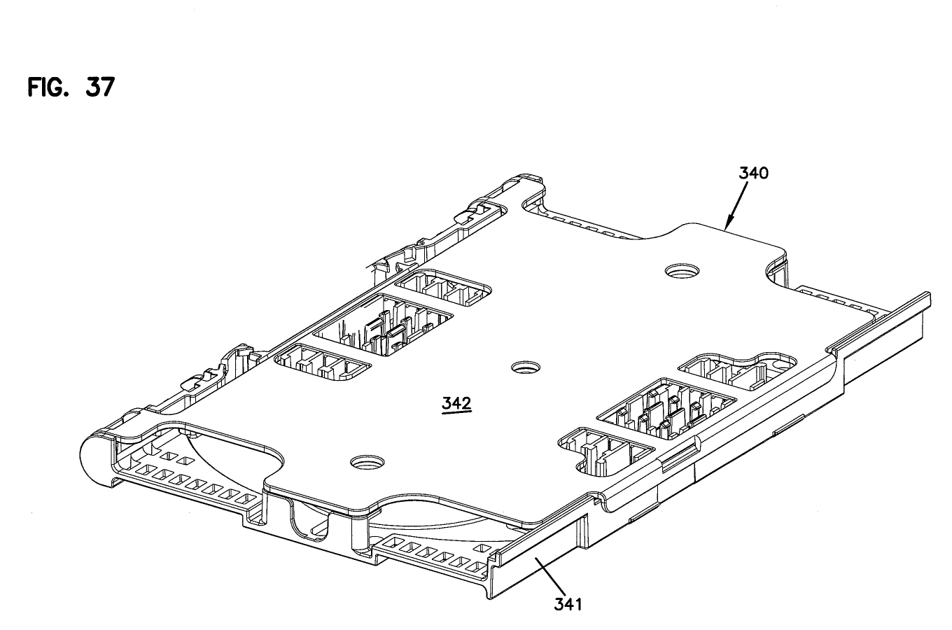

FIG. 37 in which the cover is arranged in an open position in accordance with the principles of the present disclosure;

FIG. 39 is a top, rear perspective view of a stack of example splice trays pivotally coupled together in accordance with the principles of the present disclosure;

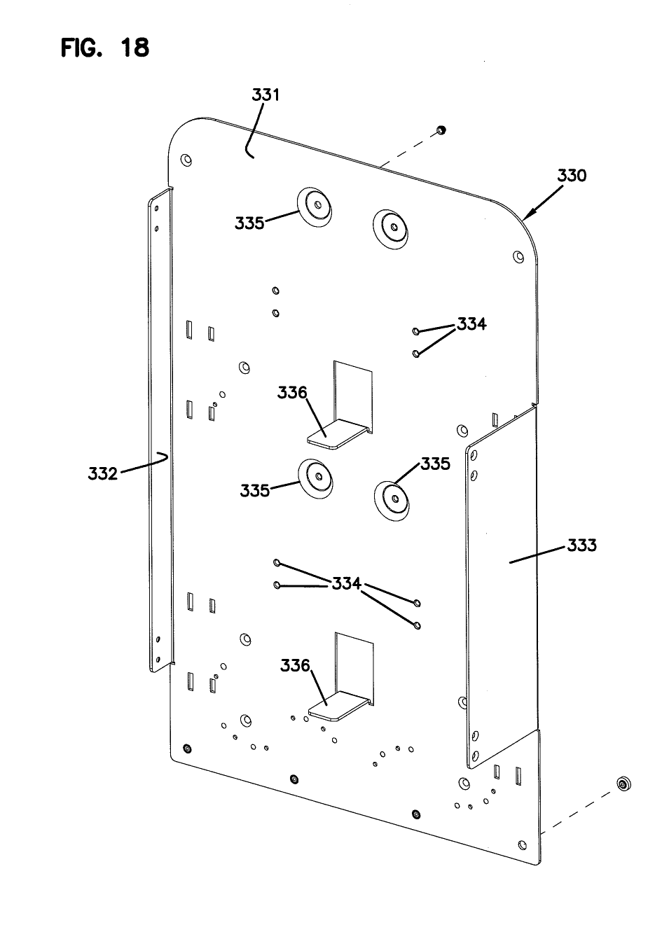

FIG. 40 is a perspective view of an example attachment member suitable for securing the example splice tray of FIG. 37 to the example support frame of FIG. 18 in accordance with the principles of the present disclosure;

FIG. 41 is a plan view of the attachment member of FIG. 40 in accordance with the principles of the present disclosure;

FIGS. 42 and 43 are side elevational views of the attachment member of FIG. 40 in accordance with the principles of the present disclosure;

FIG. 44 is a top, front perspective view of an example swing frame suitable for use in the example FDH shown in FIG. 3 in accordance with the principles of the present disclosure;

FIG. 45 is a front elevational view of the swing frame of FIG. 44 in accordance with the principles of the present disclosure;

FIG. 46 is a top plan view of the swing frame of FIG. 44 in accordance with the principles of the present disclosure;

FIG. 47 is a side elevational view of the swing frame of FIG. 44 in accordance with the principles of the present disclosure;

FIG. 48 is a front view of an example FDH including a swing frame arranged in an open position to enable access to a support frame, wherein an interface region is visible on the support frame, and wherein a splitter region and a storage region are partially visible on the swing frame in accordance with the principles of the present disclosure;

FIG. 49 is a side elevational view of an example splitter module suitable for use in the example FDH shown in FIG. 3 in accordance with the principles of the present disclosure;

FIG. 50 is an exploded, perspective view of the example splitter module of FIG. 49 in which internal components of the example splitter module are visible;

FIG. 51 is a schematic representation of a telecommunications component including the example splitter module of FIG. 49 and a storage module configured in accordance with the principles of the present disclosure;

FIG. 52 is a front view of the example FDH of FIG. 48 in which the swing frame is arranged in a closed position, wherein a splitter region, a termination region, and a storage region are provided on the swing frame in accordance with the principles of the present disclosure;

FIG. 53 is a top, front perspective view of an example storage module in accordance with the principles of the present disclosure;

FIG. 54 is a top, rear perspective view of the example storage module of FIG. 53 in accordance with the principles of the present disclosure;

FIG. 55 is a bottom, rear perspective view of the example storage module of FIG. 53 in accordance with the principles of the present disclosure;

FIG. 56 is a cross-sectional view of the example storage module of FIG. 53 taken along a longitudinal axis of the storage module in accordance with the principles of the present disclosure;

FIG. 57 is perspective view of an example termination module including an adapter module slideable mounted to a base, the adapter module being arranged in a retracted position, in accordance with the principles of the present disclosure;

FIG. 58 is a perspective view of the example termination module of FIG. 57 in which the adapter module is arranged in an extended position relative to the base in accordance with the principles of the present disclosure;

FIG. 59 is a front view of an example FDH including a support frame, a pass-through frame, and a swing frame, wherein the swing frame is arranged in an open position to enable access to a subscriber line routed between a fanout and an example interface device in accordance with the principles of the present disclosure;

FIG. 60 is a top perspective view of a cable manager suitable for use in an FDH, wherein the cable manager is equipped with multiple strength member tie-offs, multiple cable stays and multiple wedges, in accordance with the principles of the present disclosure;

FIG. 61 is a top plan view of the example cable manager of FIG. 60 in accordance with the principles of the present disclosure;

FIG. 62 is a side elevational view of the example cable manager of FIG. 60 in accordance with the principles of the present disclosure;

FIG. 63 is a top plan view of the example cable manager of FIG. 60 in which the strength member tie-offs, cable stays, and wedges have been removed in accordance with the principles of the present disclosure;

FIG. 64 is a bottom plan view of the example cable manager of FIG. 63 in accordance with the principles of the present disclosure;

FIG. 65 is a side elevational view of the example cable manager of FIG. 63 in accordance with the principles of the present disclosure;

FIG. 66 shows two round output cables being routed through a seal and being secured to the example cable manager of FIG. 63 using strength member tie-downs in accordance with the principles of the present disclosure;

FIG. 67 is a side elevational view of the round output cables being secured to the cable manager as shown in FIG. 66 in accordance with the principles of the present disclosure;

FIG. 68 is a top plan view of the round output cables being secured to the cable manager of FIG. 66 in accordance with the principles of the present disclosure;

FIG. 69 is a bottom perspective view of an example cable stay suitable for use with the example cable manager shown in FIG. 63 in accordance with the principles of the present disclosure;

FIG. 70 is a front view of the example cable stay of FIG. 69 in accordance with the principles of the present disclosure;

FIG. 71 is a top, front perspective view of an example wedge suitable for use with the example cable manager shown in FIG. 63 in accordance with the principles of the present disclosure;

FIG. 72 is a front elevational view of the example wedge of FIG. 71 in accordance with the principles of the present disclosure;

FIG. 73 is a side elevational view of the example wedge of FIG. 71 in accordance with the principles of the present disclosure;

FIG. 74 is a top plan view of the example wedge of FIG. 71 in accordance with the principles of the present disclosure;

FIG. 75 shows a flat output cable being routed through a seal and being secured to the example cable manager of FIG. 63 using a cable stay and a wedge in accordance with the principles of the present disclosure;

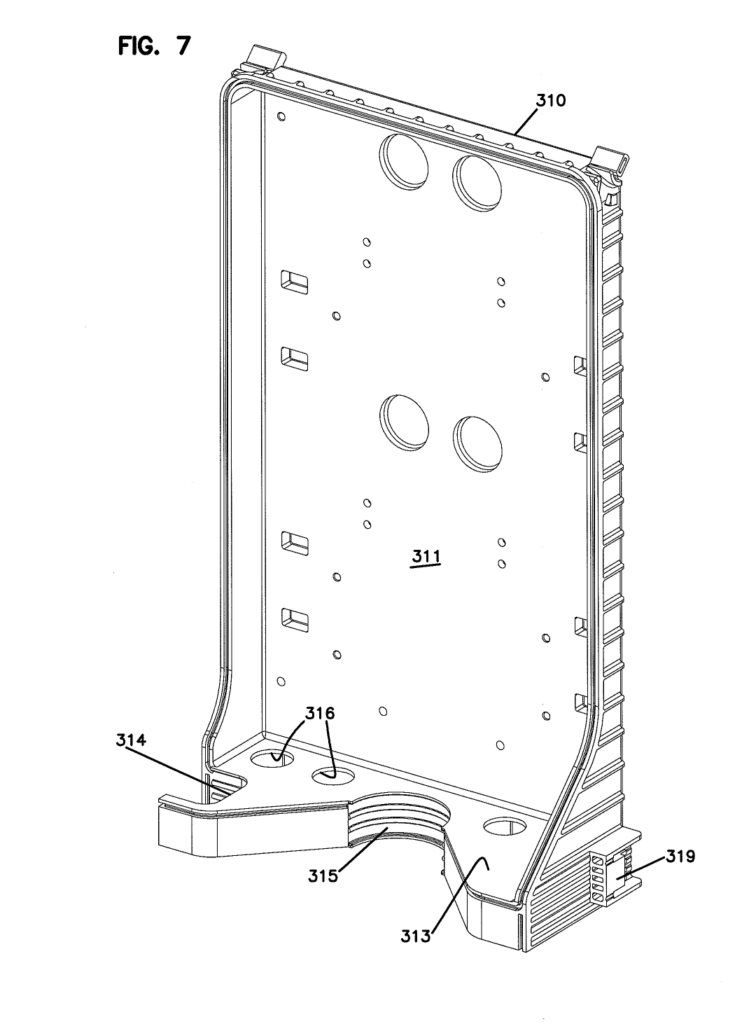

FIG. 76 is a top perspective view of an example cable seal suitable for use at a cable port of the example FDH support shown in FIG. 7 in accordance with the principles of the present disclosure;

FIG. 77 is a top plan view of the example cable seal of FIG. 76 in accordance with the principles of the present disclosure;

FIG. 78 is a partial view of the cable seal of FIG. 76 as defined by detail indicia A of FIG. 77 in accordance with the principles of the present disclosure;

FIG. 79 is a top, front perspective view of an example FDH in which a cover has been pivoted upwardly to an open position, a pass-through frame has been pivoted laterally outwardly in a first direction, and a swing frame has been pivoted laterally outwardly in a second direction;

FIG. 80 is a top, front perspective view of the example FDH shown in FIG. 79 in which the back of the swing frame is visible;

FIG. 81 is a top, front perspective view of an example swing frame suitable for mounting in any of the above-described FDHs;

FIG. 82 is a top, rear perspective view of the example swing frame of FIG. 81; and

FIGS. 83-86 illustrate another example implementation of an FDH including another example implementation of a cable manager and an additional cable port in accordance with the principles of the present disclosure.

### DETAILED DESCRIPTION

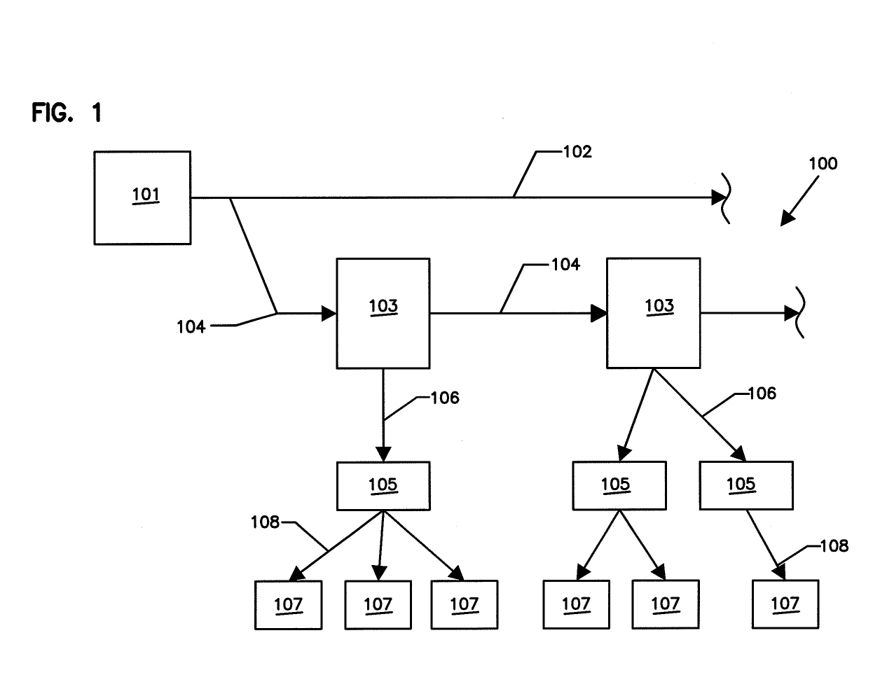

FIG. 1 illustrates an example network 100 deploying passive fiber optic lines. As shown, the network 100 includes a central office 101 that connects a number of end users 107. The central office 101 can additionally connect to one or more larger networks, such as the Internet (not shown) and a public switched telephone network (PSTN). An example feeder cable 104 in the network 100 is branched out from main cable lines 102 and routed to a fiber distribution terminal (e.g., a hub or a pedestal) 103. Of course, multiple feeder cables can branch out from the main cables 101 and be routed to pedestal terminals and/or fiber distribution hubs.

Each fiber distribution terminal 103 generally administers connections at a termination panel between incoming fiber and outgoing fiber. The fiber distribution terminal 103 includes one or more splitters, which facilitate optical coupling between fibers of the feeder cable 104 and one or more output cables 106. The output cables 106 can be routed to one or more drop terminals 105. One or more drop cables 108 are routed from the drop terminals 105 to the subscribers 107 to which service may be provided. In accordance with one aspect, the drop cables 108 are routed to optical network terminals (ONTs) that are arranged at end users 107. In accordance with other aspects, however, the output cables 106 can be routed directly to the subscribers or to other desired locations. The various lines of the network 100 can be aerial or housed within underground conduits.

As the term is used herein, “a connection” between fibers includes both direct and indirect connections. Examples of incoming optical fibers as the term is used herein include the fibers of a feeder cable 104 that enters the terminal 103 and intermediate fibers that connect the feeder cable fibers to the termination region as will be described in greater detail herein. Examples of such intermediate fibers include connectorized pigtails extending from one or more splitters and fibers that extend from a splitter and that are spliced or otherwise connected to the feeder cable. Examples of outgoing fibers as the term is used herein include the fibers of the output cables 106 that exit the terminal 103 and any intermediate fibers that connect the output cables 106 to the termination region.

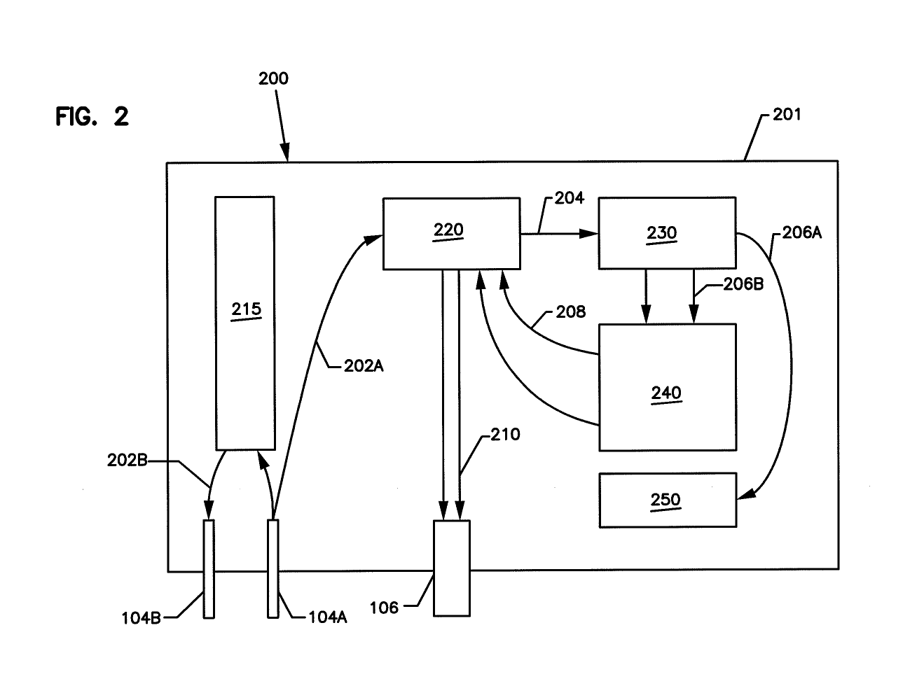

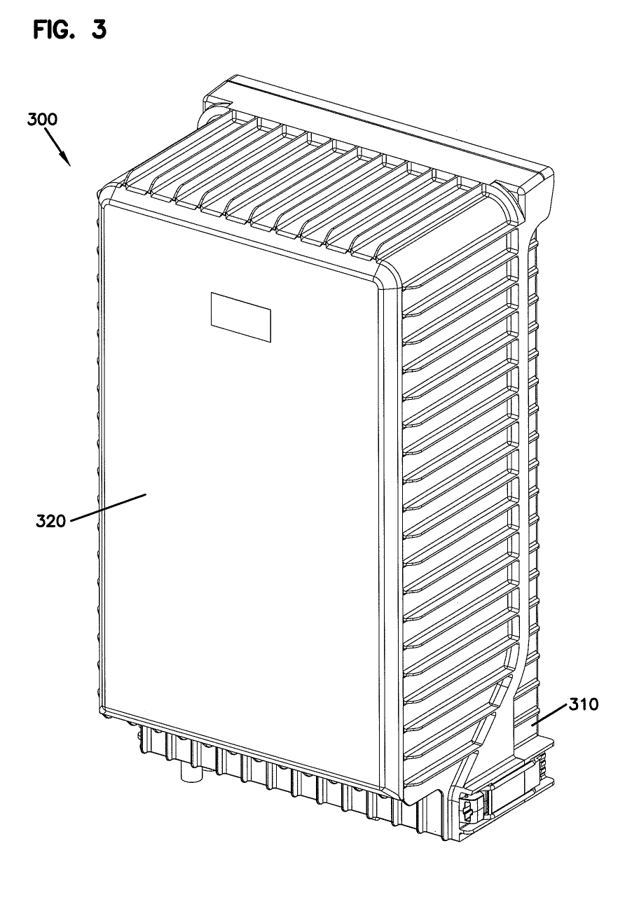

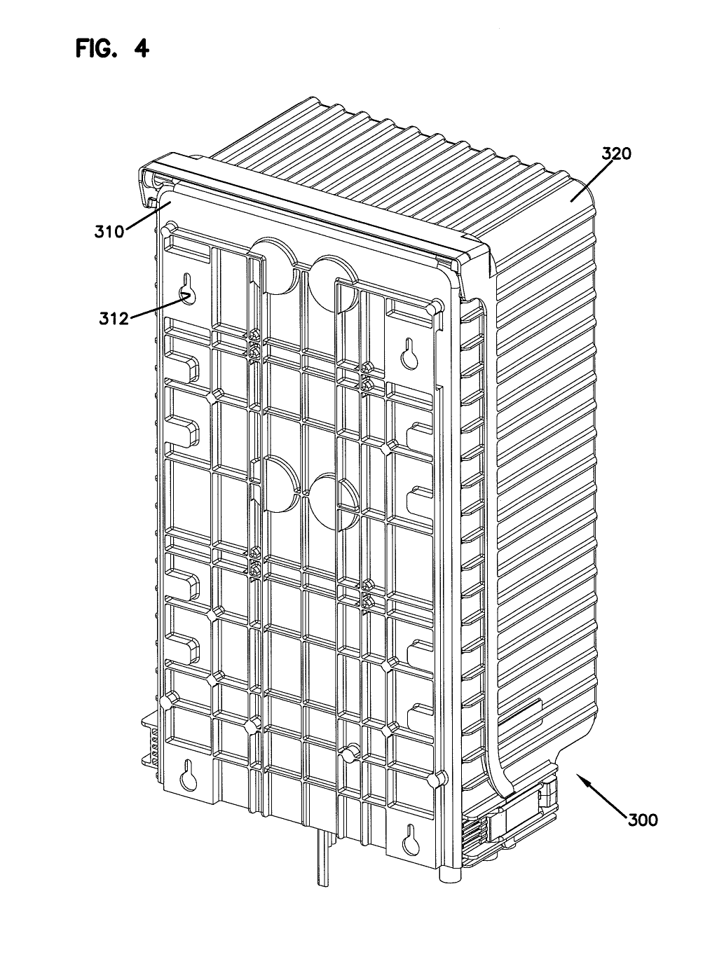

FIG. 2 is a schematic representation of an example fiber distribution hub (FDH) 200 suitable for use as a fiber distribution terminal 103 in a telecommunications network 100 (see FIG. 1). The FDH 200 includes a body 201 in which fibers of one or more incoming cables are connected to fibers of one or more outgoing cables. For example, fibers of one or more feeder cables 104 can be connected to fibers of one or more output cables 106. The body 201 defines at least one cable entrance port through which a feeder cable 104 can enter the FDH 200. The body 201 also defines at least one cable exit port through which an output cable 106 can exit the FDH 200.

The fibers of the feeder cable 104 can include ribbon fibers or loose tube fibers. An example feeder cable 104 may include twelve to forty-eight individual fibers connected to a service provider central office 101 (FIG. 1). In accordance with some aspects, one example feeder cable 104 can be a stub cable. As the term is used herein, a stub cable is a fiber optic cable for which all optical fibers are routed to the termination field in the FDH 200. In accordance with other aspects, one example feeder cable 104 can be a pass-through cable. As the term is used herein, a pass-through cable is a fiber optic cable for which at least one optical fiber bypasses the termination field. In the example shown in FIG. 2, the feeder cable 104 is a pass-through cable.

The fibers of the output cable 106 can include ribbon fibers or loose tube fibers. An example output cable 106 can includes multiple fibers (e.g., 144, 216, or 432 fibers) that are routed from the fiber distribution terminal 103 to subscriber locations 109 (FIG. 1). In accordance with some aspects, one example output cable 106 can be a stub cable. In accordance with other aspects, an example output cable 106 can be a round cable. In accordance with still other aspects, an example output cable 106 can be a flat cable.

In accordance with some aspects, the fibers of the output cable 106 can be individually terminated by fiber optic connectors. In accordance with other embodiments, the fibers of the output cable 106 can be terminated with a multi-termination connector (i.e., a multi-fiber connector) which can be optically coupled to a subscriber cable terminated at a multi-termination connector. Further details regarding multi-fiber connector-terminated intermediate fibers can be found in copending U.S. application Ser. No. 11/513,910, filed Aug. 30, 3006 as “Fiber distribution hub with modular termination blocks,” the disclosure of which is hereby incorporated herein by reference.

In general, the body 201 defines a splitter region 230 at which an optical signal can be split into a plurality of optical signals and a termination region 240 at which connectorized ends of optical fibers can be optically coupled. In accordance with some aspects, the body 201 also can define a fiber interface region 220 at which incoming and outgoing optical fibers can be connected to precabled optical fibers. In accordance with other aspects, the body 201 also can define a storage region 250 at which the connectorized ends of optical fibers can be stored temporarily. In accordance with other aspects, the body 201 can define a pass-through management region 215 at which fibers of a pass-through cable that will not be routed to the termination region 230 can be organized and managed.

In the example shown in FIG. 2, the termination region 240 is located beneath the splitter region 230 and above the storage region 250. In accordance with other aspects, however, the telecommunication components can be arranged in different configurations within the body 201. One or more cable management structures are provided at appropriate locations along the body to inhibit tangling and to limit the bend radius of the optical fibers.

FIG. 2 also shows an example cable routing scheme for a pass-through feeder cable entering the FDH 200. Fibers 202 of the feeder cable 104 can be routed initially into the body 201 at the cable entrance. At least one optical fiber 202A of the feeder cable 104 is routed to the interface region 220. In accordance with some aspects, the fibers 202A of the feeder cable 104 are routed to cable fanouts (not shown) that separate the fibers of the feeder cable 104 prior to routing the separated fibers to the splitter region 220. The fanout device also can upjacket the fibers of the feeder cable 104.

If the feeder cable is a pass-through cable, then the remaining fibers 202B of the feeder cable 104 are passed through the pass-through management region 215 prior to exiting the FDH 200. In the example shown, the feeder cable 104 is a pass-through cable that includes a first portion 104A that enters the body 201 and a second portion 104B that exits the body 201. The portions of the fibers 202B that extend between the first and second portions 104A, 104B of the cable 104 are routed through the pass-through management region 215. In accordance with some aspects, these portions of the fibers 202B are jacketed. In accordance with other aspects, the jacket can be removed from these fibers 202B. In accordance with certain aspects, the pass-through management region 215 includes one or more cable/fiber management structures (e.g., fiber spools and/or partial spools) for taking up slack cable/fiber length (e.g., see FIG. 48).

The optical fibers 202A can be optically coupled to splitter input fibers 204 at the interface region 220. In certain embodiment, the splitter input cables 204 can be precabled between the interface region 220 and the splitter region 230. In accordance with some aspects, the interface region 220 includes one or more splice trays (see FIGS. 37-39) at which the optical fibers 202A can be optically spliced to the splitter input fibers 204. In accordance with other aspects, one or more fiber optic adapters or adapter modules can be mounted at the interface region 220 for connecting the feeder cable fibers 202A with the splitter input fibers 204. In accordance with still other aspects, the feeder cable fibers 202A can bypass the interface region 220 and be routed directly to the splitter region 230.

At the splitter region 230, the splitter input fibers 204 are connected to separate splitter modules (see FIGS. 49-51). In accordance with one aspect, ends of the splitter input fibers 204 can be connectorized and, accordingly, can be connected to the splitter modules by fiber optic adapters. In accordance with another aspect, the splitter input fibers 204 can include pigtail fibers extending from the splitter modules. Each splitter module splits signals carried over the splitter input fibers 204 into multiple signals carried over splitter pigtails 206, each having a connectorized end. One example splitter pigtail 206 includes a coated (and possibly buffered) fiber, a jacket covering the fiber, and strength members (e.g., aramid yarn) positioned between the fiber and the jacket.

In accordance with certain aspects of the disclosure, at least one splitter pigtail 206 is configured to optically couple at a termination region 240 to one of the fibers 210 of the output cable 106 (e.g., see FIG. 52). For example, each splitter pigtail 206 can optically connect to a subscriber line 208 that is spliced to one of the fibers 210 of the output cable 106. When the splitter pigtails 206 are needed for service, the pigtails 206 are routed from the splitter modules to a termination module (e.g., an adapter, an adapter module, etc.) that is provided at the termination region 240. At the termination module, the connectorized end of the splitter pigtail 206 is interfaced with a connectorized end of the subscriber line 208. In accordance with certain aspects, when the splitter pigtails 206 are not in service, the connectorized ends of the splitter pigtails 206 can be temporarily stored at a storage module that is mounted at the storage region 250 (e.g., see FIG. 52).

In accordance with some aspects, the subscriber lines 208 are routed from the termination region 240 back to the interface region 220. In accordance with one aspect, the subscriber lines 208 are precabled within the body 201 of the FDH 200 to extend between the termination region 240 and the interface region 220. In accordance with some aspects, the subscriber lines 208 can be routed to cable fanouts 810 (FIG. 59) that ribbonize the subscriber lines into one or more cables that are routed to the interface region 220. At the interface region 220, the subscriber lines 208 are optically spliced to fibers 210 of the output cable 106. The output cable 106 is routed out of the body 201 of the FDH 200 for distribution to subscribers 109 (FIG. 1). In accordance with other aspects, the ribbonized subscriber lines 208 can bypass the interface region 220 and form the output cable 106 themselves.

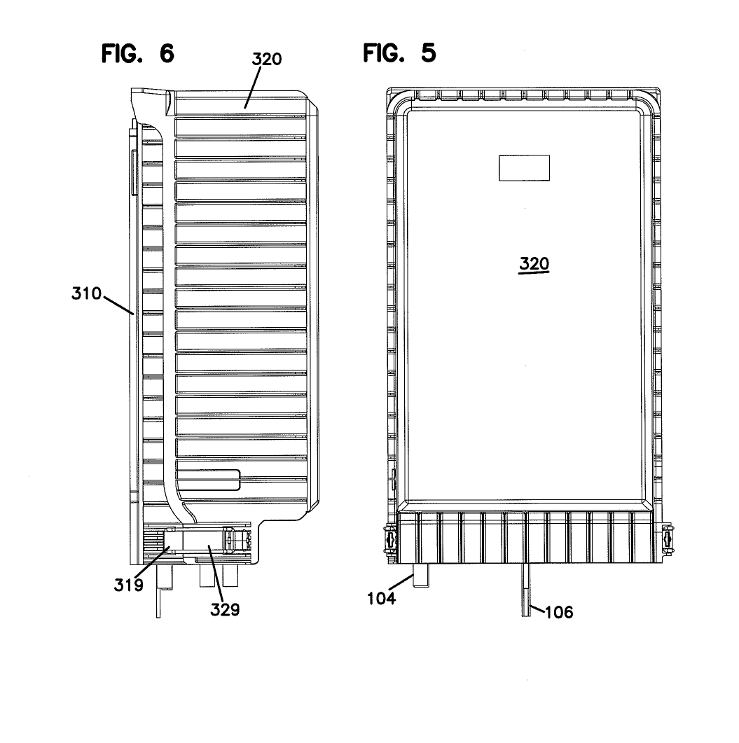

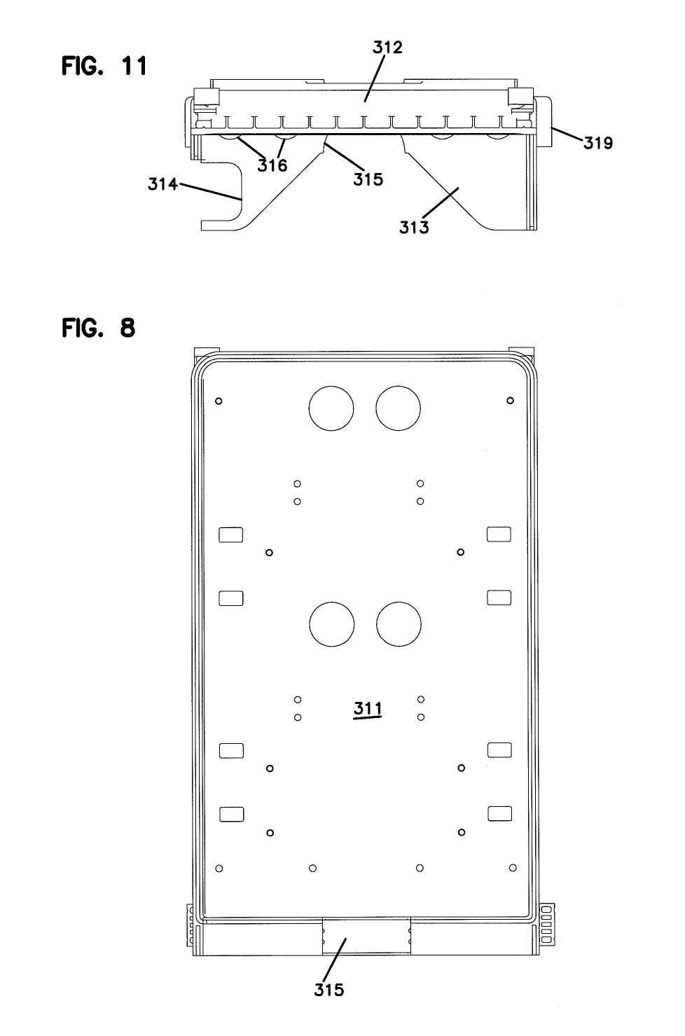

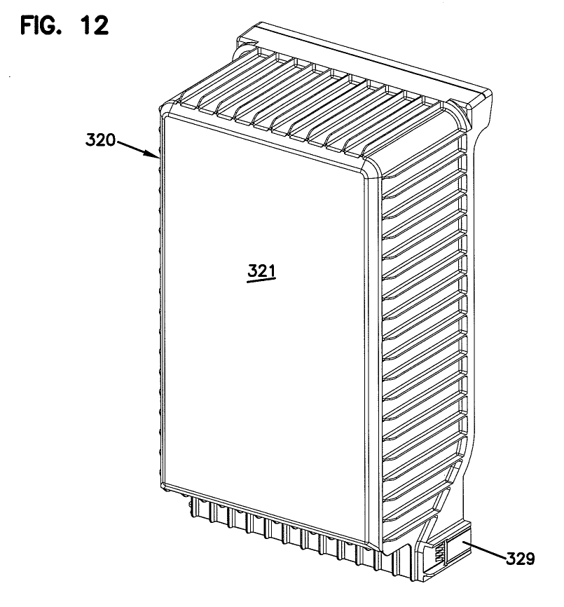

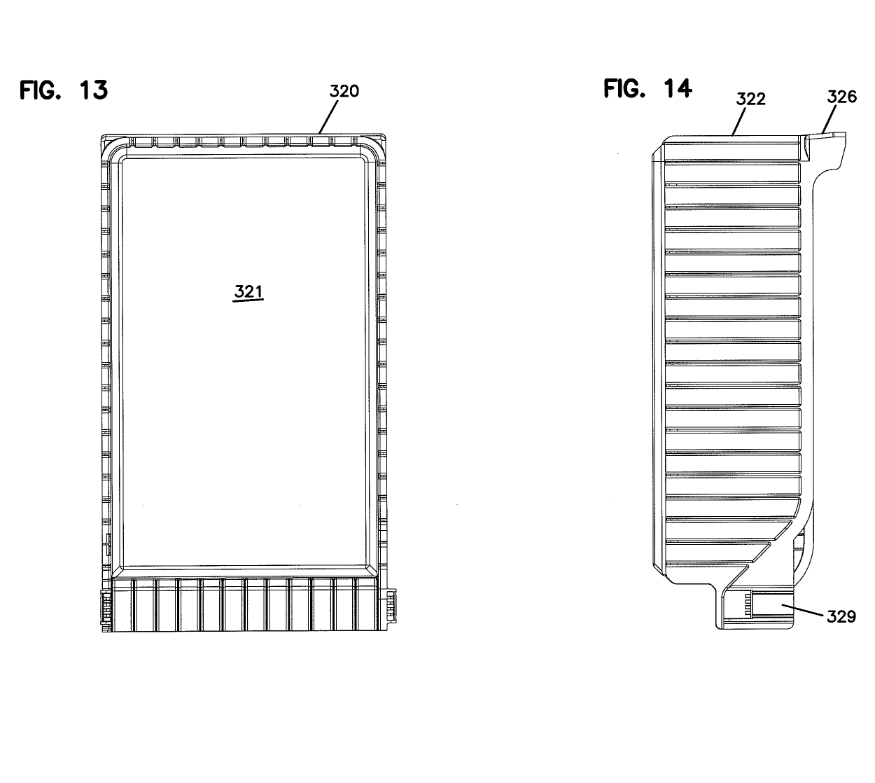

Referring now to FIGS. 3-17, one example FDH 300, which is suitable for use as a fiber distribution terminal 103 in network 100 of FIG. 1, is shown. The FDH 300 can be configured to interface incoming and outgoing cables as shown in FIG. 2. The FDH 300 includes a base 310 and a cover 320 that is pivotally mounted to the base 310. Telecommunications components can be mounted to the base 310 and protected by the cover 320.

The base 310 includes a tray 311 defining mounting openings 312 through which a fastener can be inserted to secure the base 310 to a mounting surface (e.g., a wall, a panel, a tree, etc.). The tray 311 includes a first side 313 that defines at least one entrance/exit port. In the example shown, the first side 313 is a bottom wall of the tray 311. In accordance with some aspects, the bottom wall 313 defines one or more feeder cable ports 314. In accordance with other aspects, the bottom wall 313 also defines at least one output cable port 315. In accordance with still other aspects, the bottom wall 313 also can define one or more stub cable ports 316. Routing of the incoming and outgoing cables through the ports will be discussed in greater detail herein.

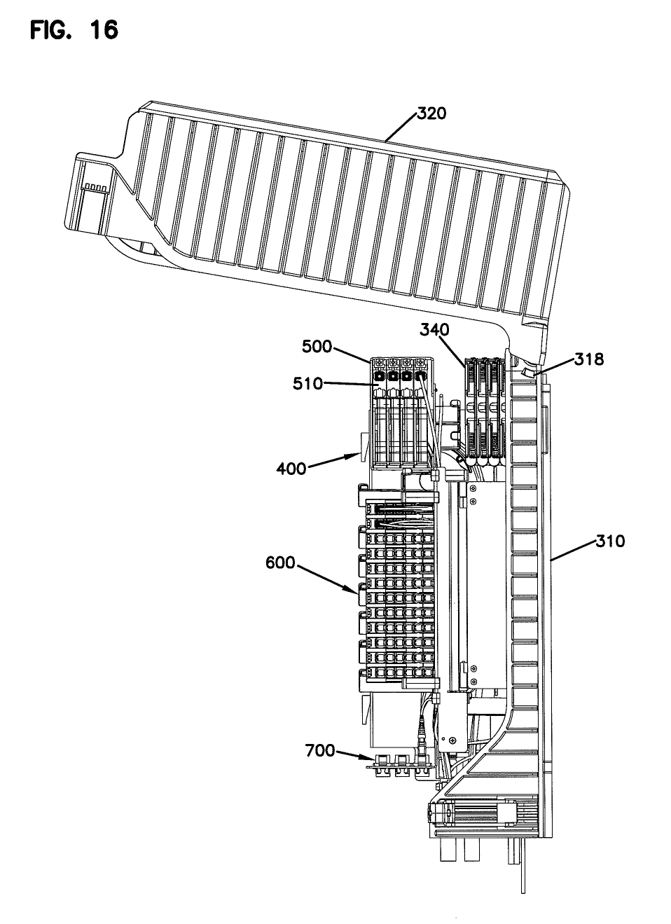

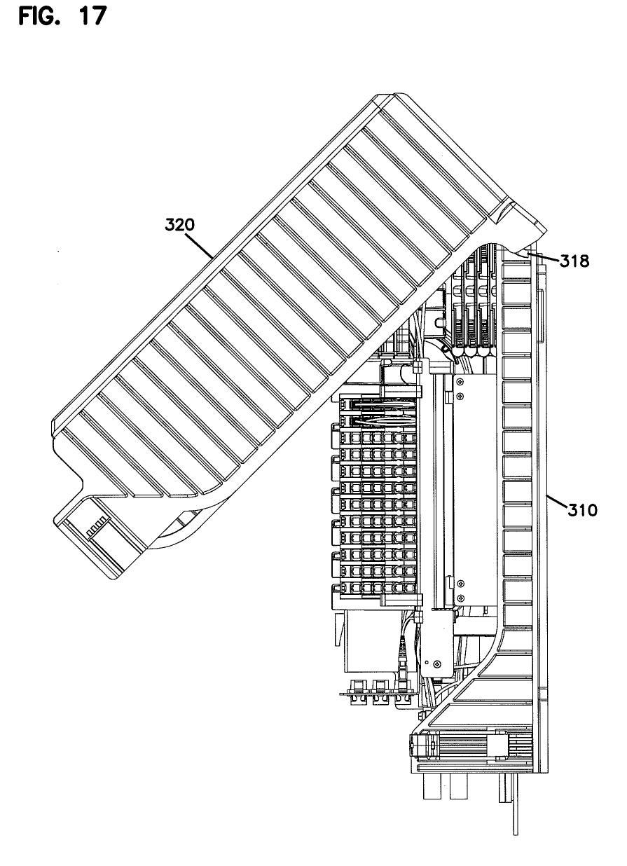

The base 310 and cover 320 define a hinge assembly that enables the cover 320 to pivotally attach to the base 310. In accordance with some aspects, the cover 320 is configured to pivot from a closed position (see FIG. 3) to at least a first open position (see FIG. 16) to enable access to telecommunications components mounted within the FDH 300. In accordance with other aspects, the cover 320 also can be configured to pivot to a second open position (see FIG. 17) that enables partial access to the interior of the FDH 300. For example, pivoting the cover 320 to the second open position can enable access to the cable entrance and exit ports that will be discussed in greater detail herein. In accordance with one aspect, the cover 320 is oriented at an angle of about 100° (give or take 25°) when arranged in the first open position and is oriented at an angle of about 45° (give or take 25°) when arranged in the second open position.

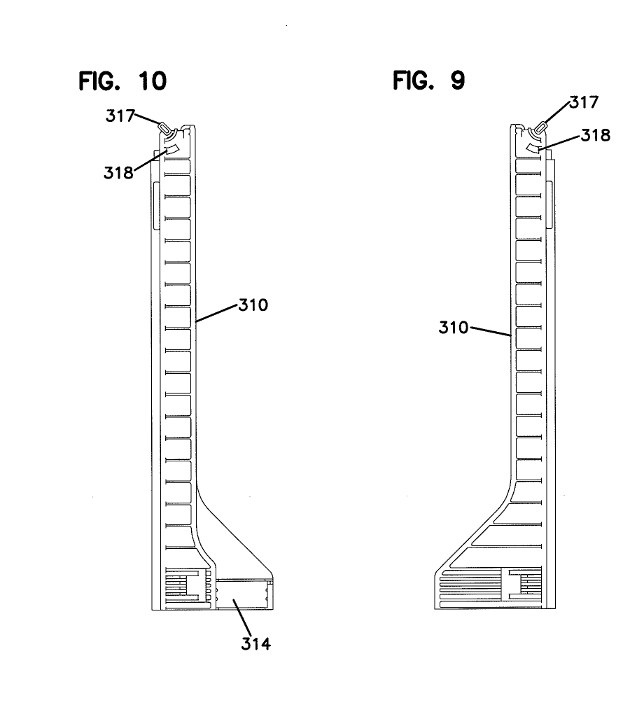

The portion of the hinge assembly defined by the base 310 includes a first hinge member 317 about which the cover 320 can pivot. The example first hinge member 317 shown in FIGS. 9 and 10 defines opposing straight sides extending between opposing rounded sides. The base 310 also includes at least one stop member 318. The base 310 also includes first portion 319 of a latching assembly that can interact with a second portion 329 on the cover 320 to secure the cover 320 to the base 310 in a closed position.

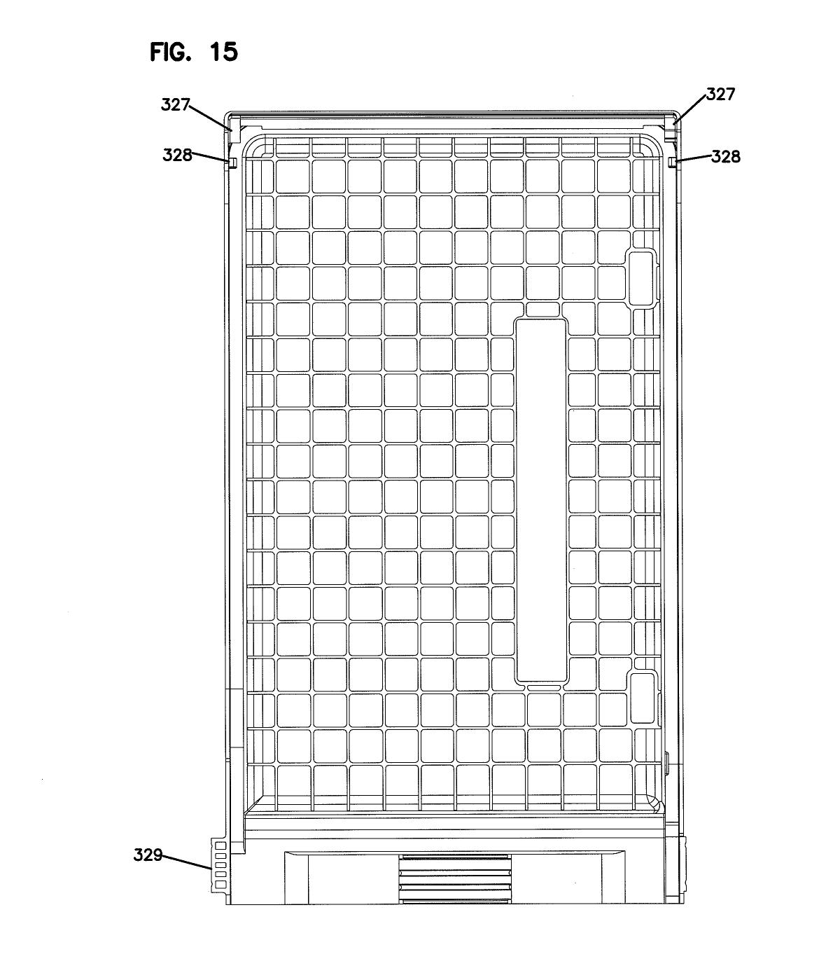

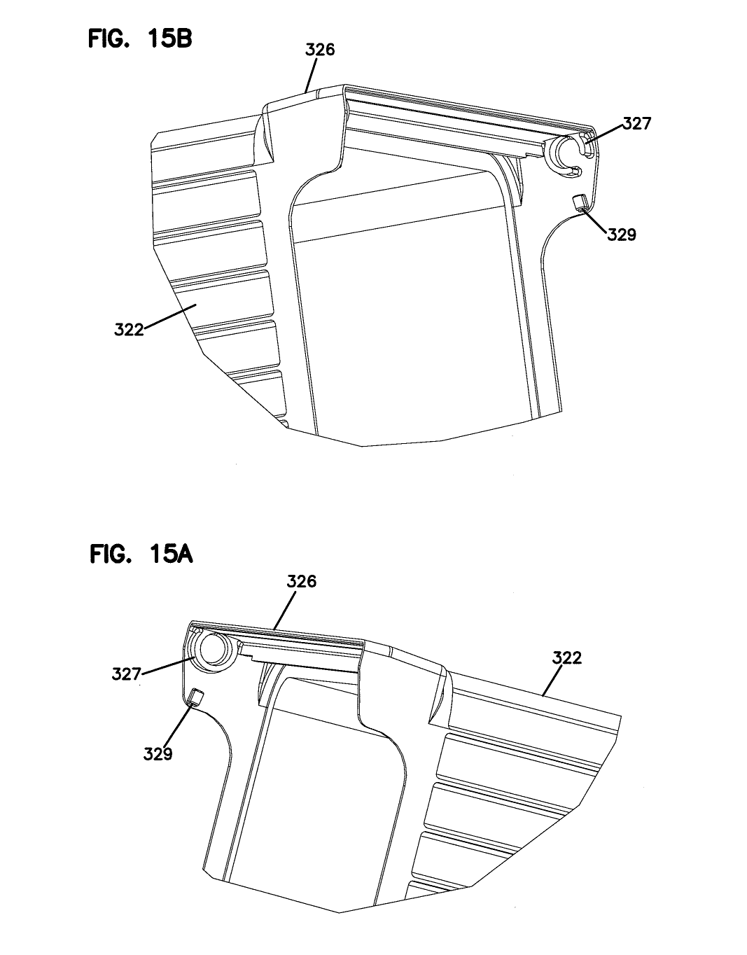

The cover 320 includes a front panel 321 and side walls 322 extending rearwardly of the front panel 321. The cover 320 also includes a mounting section 326, which defines another portion of the hinge assembly that enables the cover 320 to pivotally attach to the base 310. For example, the mounting section 326 includes a second hinge member 327. The example second hinge member 327 defines a generally circular shape in which the first hinge member 317 can rotate. In accordance with one aspect, the mounting section 326 provides one second hinge member 327 that defines a full circle on one side of the mounting section 326 (see FIG. 15A) and another second hinge member 327 that defines a broken circle on another side of the mounting section 326 (see FIG. 15B). The second hinge member 327 defining the broken circle enables the first hinge member 317 of the base 310 to align with and to slide through the break to facilitate removal of the cover 320 from the base 310.

The cover 320 also includes at least one stop member 328 that is configured to interact with the one or more stop members 318 of the base 310. The stop members 318 of the base 310 and/or the stop member 328 of the cover 320 are sufficiently cammed to allow the stop member 328 of the cover 320 to ride over the stop members 318 of the base when a sufficient amount of force is applied. The stop members 318, 328 also each define a sufficient shoulder to allow an abutment of the stop member 328 of the cover 320 against the stop member 318 of the base to retain the cover 320 is a fixed position with respect to the base until the sufficient amount of force is applied. In the example shown, the base 310 includes two stop members 318 and the cover 320 includes one stop member 328. In accordance with other aspects, however, the base 310 and cover 320 can include any desired number of stop members.

A frame configured to hold telecommunications components can be mounted to the base 310. The frame includes a support frame 330 that can be configured to define an interface region, such as interface region 220 of FIG. 2, as will be described in greater detail herein. In some implementations, the support frame 330 is integral with the base 310. A pass-through frame 360 and a swing frame 400 can be mounted to the support frame 330. In the example support frame 330 shown in FIG. 18, the support frame 330 includes a support panel 331, a first side member 332, and a second side member 333. In accordance with one aspect, the pass-through frame 360 can be mounted to the first side member 332 and the swing frame 400 can be mounted to the second side member 333 as will be described in greater detail herein.

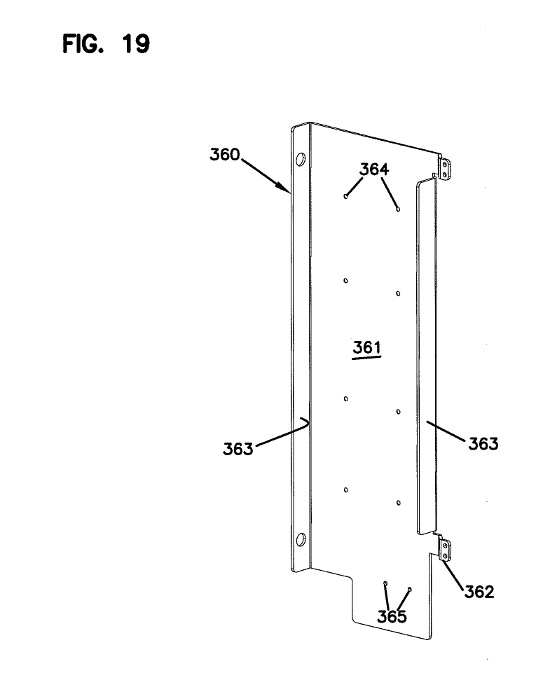

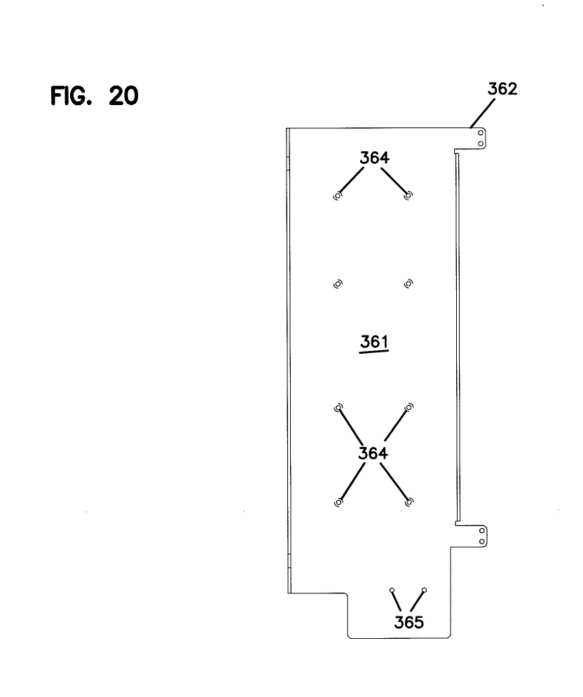

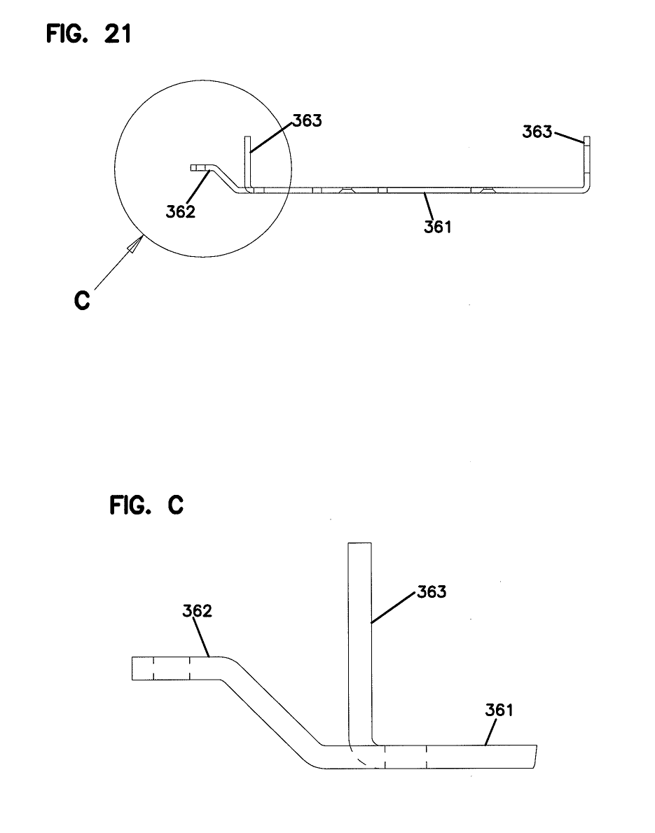

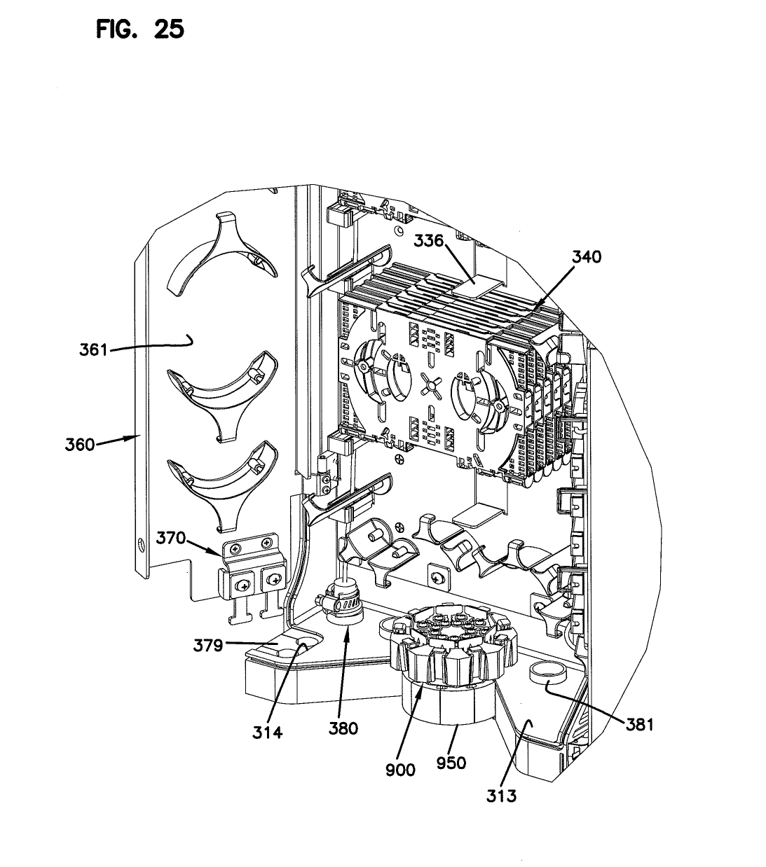

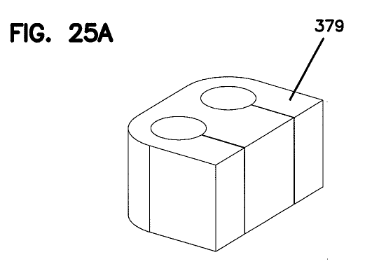

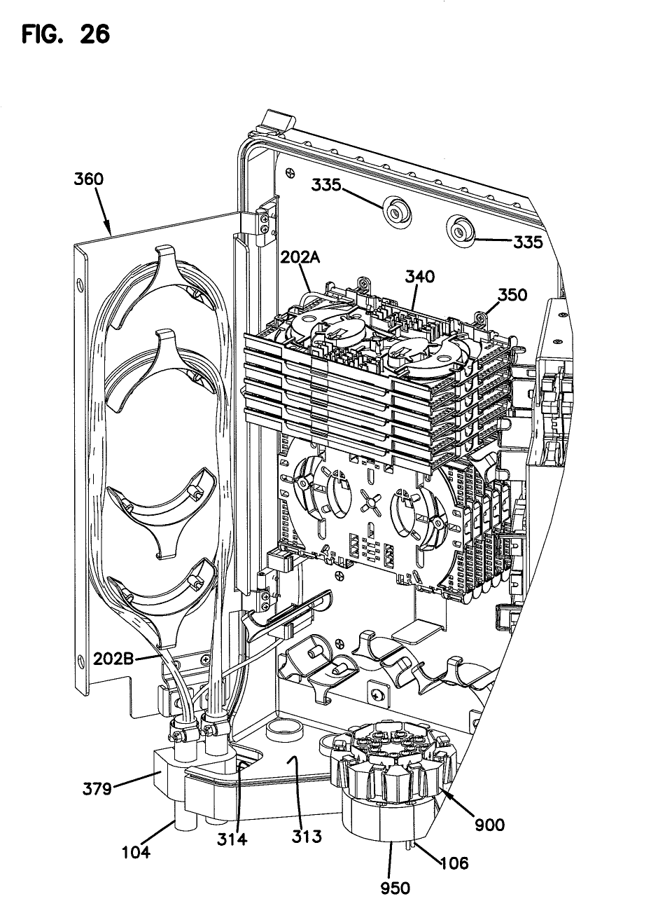

FIGS. 19-21 illustrate one example pass-through frame 360 that can mount to the support frame 330. The pass-through frame 360 includes a panel 361 having mounting members 362 and side walls 363. The mounting members 362 are configured to facilitate attachment of the pass-through panel 360 to the first side member 332 of the support frame 330. The pass-through frame 360 is configured to provide support for one or more cable/fiber management structures. For example, the panel 361 can define one or more openings that facilitate mounting of cable/fiber management structures (e.g., fiber spools, bend radius limiters, retention clips, etc.). FIGS. 25 and 26 shows one example cable/fiber management structure mounted to the panel 361.

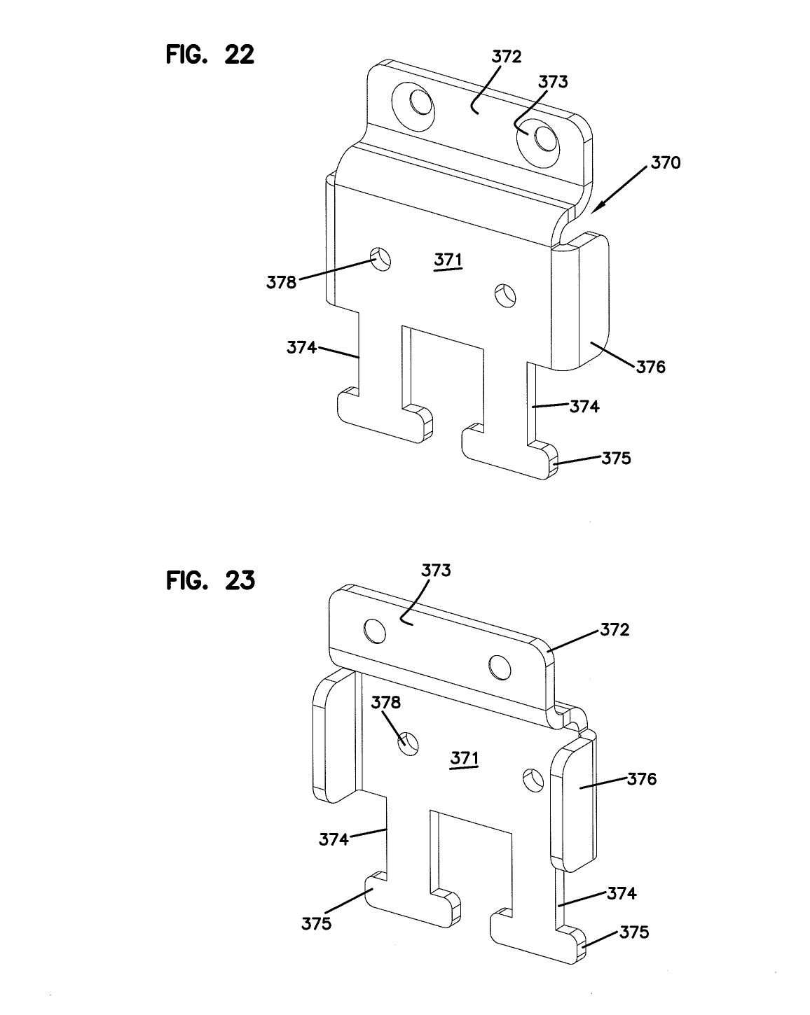

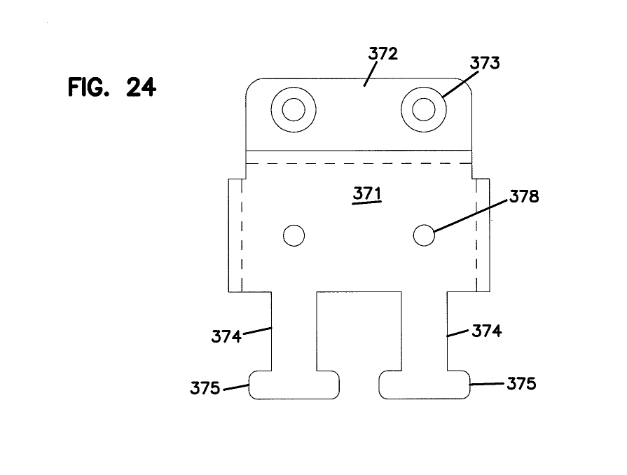

The pass-through frame 360 also is configured to provide support for at least one pass-through feeder cable entering the FDH 300. For example, the panel 361 can define one or more openings 365 that facilitate mounting of a cable securement device. One example cable securement device 370 is shown in FIGS. 22-24. The example cable securement device 370 includes a base 371 having a mounting portion 372 by which the cable securement device 370 can be secured to the pass-through frame 360. In accordance with one aspect, the mounting portion 372 defines one or more apertures 373 aligned with openings 365 and through which a fastener can be passed to secure the securement device 370 to the panel 361 (see FIG. 25).

The securement device 370 also includes sides 376 and legs 374 extending downwardly from the base 371. In accordance with one aspect, the sides 374 can be defined by bent sections of the base 371. The legs 374 define feet 375. Feeder cables 104 routed into the FDH 300 can be secured to the pass-through frame 360 by clamping the feeder cable 104 to the legs 374 of the securement device 370 (e.g., with a hose clamp). The feet 375 facilitate retention of the hose clamp around the legs 374 as shown in FIG. 26. The base 371 also can be configured to receive and retain strength members of the feeder cables 104. For example, the base 371 can define openings through which a screw or other strength member retention device can be installed.

In accordance with certain aspects, a pass-through type feeder cable 104 can pass through a sealing member 379 when entering the FDH 300 (see FIG. 25A). The sealing member 379 fits within the feeder cable port 314. In the example shown in FIGS. 25 and 26, the sealing member 379 defines two openings each connected to an exterior surface of the sealing member 379 by a slit through which the cables can pass. In accordance with one aspect, the incoming portion of the feeder cable 104A can pass through one opening and the outgoing portion of the feeder cable 104B can pass through the other opening (see FIG. 26).

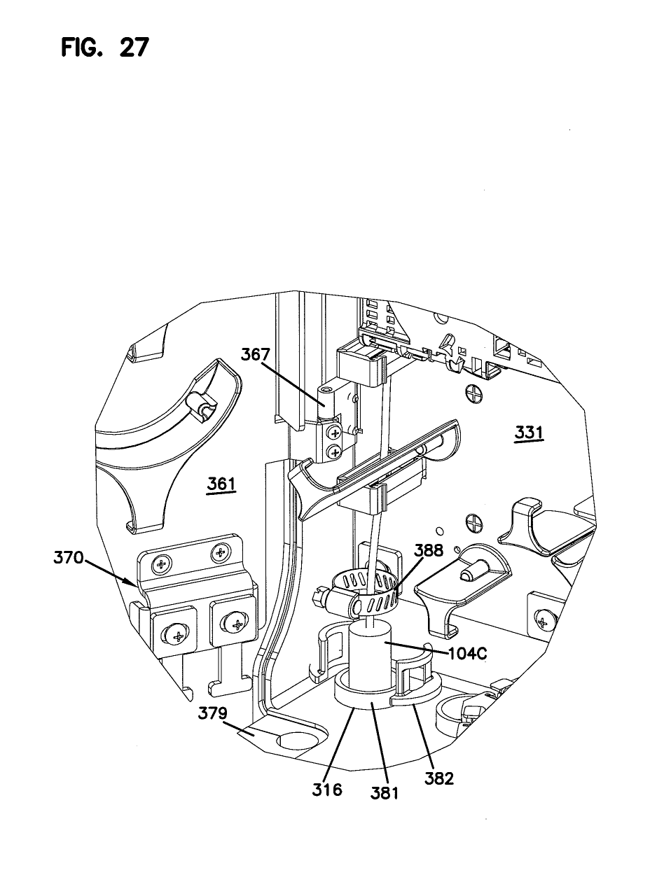

In accordance with some aspects, the pass-through frame 360 can be pivotally mounted to the support frame 330. For example, the pass-through frame 360 can mount to hinge members 367 (see FIG. 27), which mount to the first side 332 of the support panel 331. In accordance with certain aspects, the pass-through frame 360 can be pivoted through a limited range to facilitate access to the telecommunications components mounted within the FDH 300. For example, in accordance with one aspect, the pass-through frame 360 can be pivoted from a first position in which the securement device 370 and sealing member 379 align with the feeder cable port 314 (see FIGS. 27 and 52) to a second position providing enhanced access to the back corners of the FDH base 310 (see FIGS. 26 and 48).

FIG. 27 illustrates the securement of a stub-type feeder cable 104C entering the FDH 300 through a stub cable port 316. The fibers of the stub-type feeder cable 104 are routed to the interface region of the FDH 300. Seals 381 are provided in the stub cable ports 316 to inhibit contamination of the telecommunications components stored inside the FDH 300. In the example shown, the seals 381 include annular rings mounted within the stub cable ports 316 through which the stub cables (e.g., stub feeder cable 104C) can pass. In accordance with other aspects, other types of seals can be utilized (e.g., linear seals that can be wrapped around the cable at the port 316).

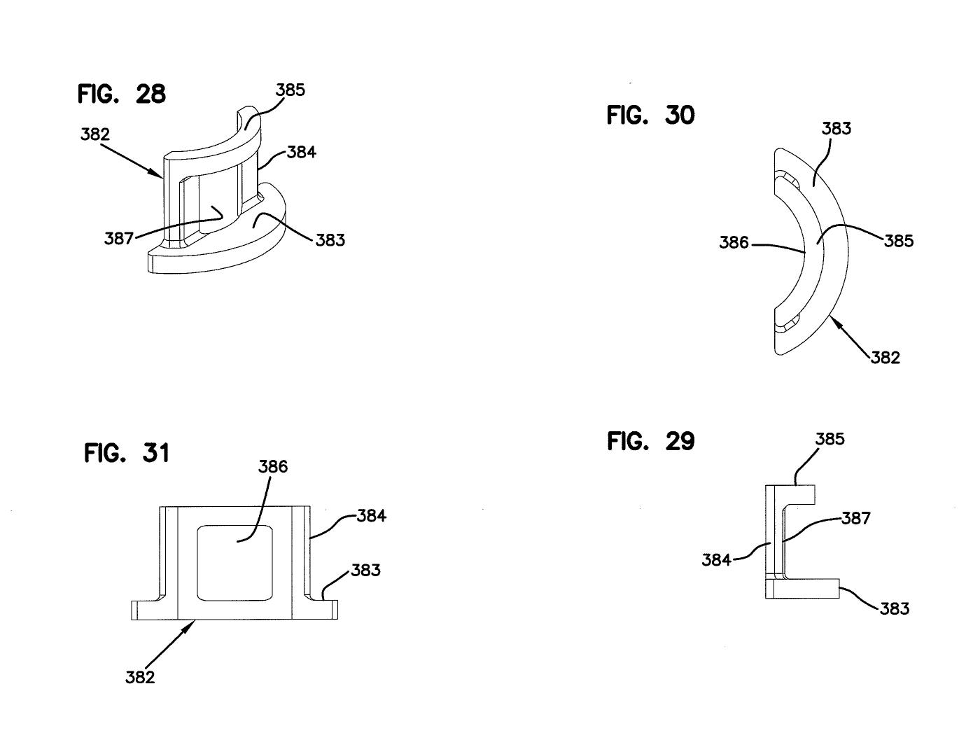

To facilitate retention of the stub cables in the FDH 300, the stub cables can be secured to the base 310 with at least one top-hat clamps 382, a hose clamp 388, and a strength member tie-off 389 (see FIGS. 25 and 27). An example top-hat clamp 382 is shown in FIGS. 28-30. In accordance with certain embodiments, the top-hat clamp 382 defines a generally semi-circular shape. Accordingly, two or more top-hat clamps 382 can be positioned about a stub cable (e.g., see FIG. 27). The top-hat clamps 382 include a base 383 that is configured to seat on the seals 381 or on the bottom wall 313 of the base 310. An extension member 384 extends upwardly from the base 383. A retention member 385 protrudes outwardly from the extension member 384.

The extension member 384 defines a generally concave interior surface 386 that is configured to contact the stub cable. The extension member 385 also defines a generally convex exterior surface 387 that is configured to receive a hose clamp 388. The base 383 and the retention member 385 protrude outwardly from the extension member 384 sufficient to aid in retaining the hose clamp 388 on the top-hat clamp 382. The base 383 also extends outwardly from the extension member 384 sufficient to seat stably on the seal 381. Strength members of stub cables can be retained at the strength member tie-off 389 (see FIGS. 27 and 48). The strength member tie-off 389 can be mounted to the FDH base 310 or to the support panel 330.

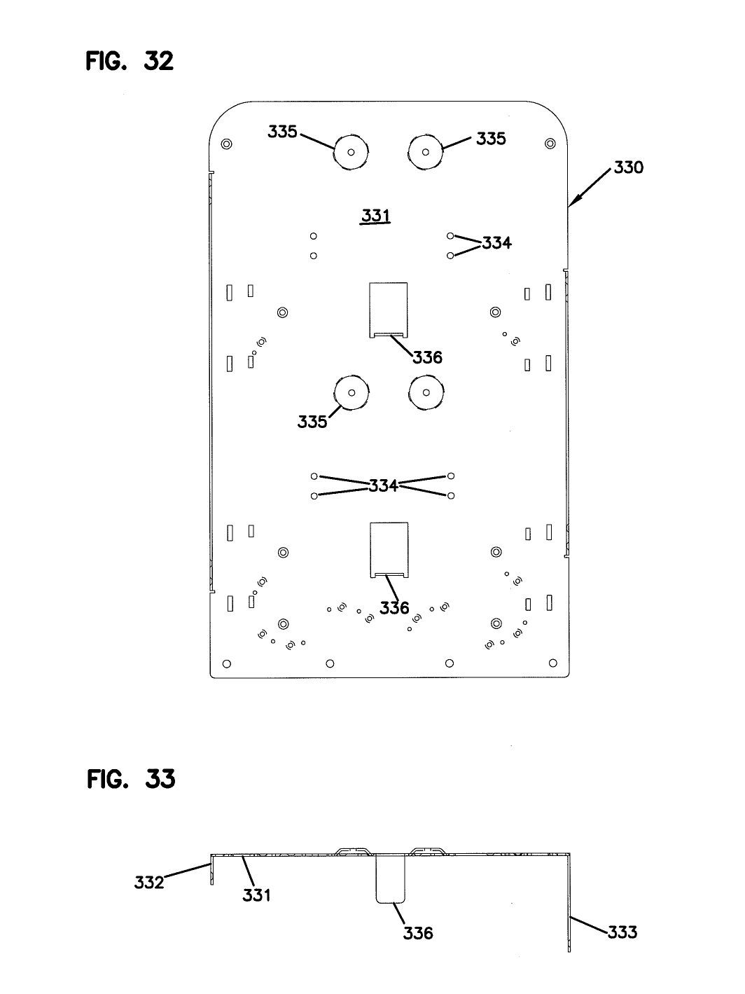

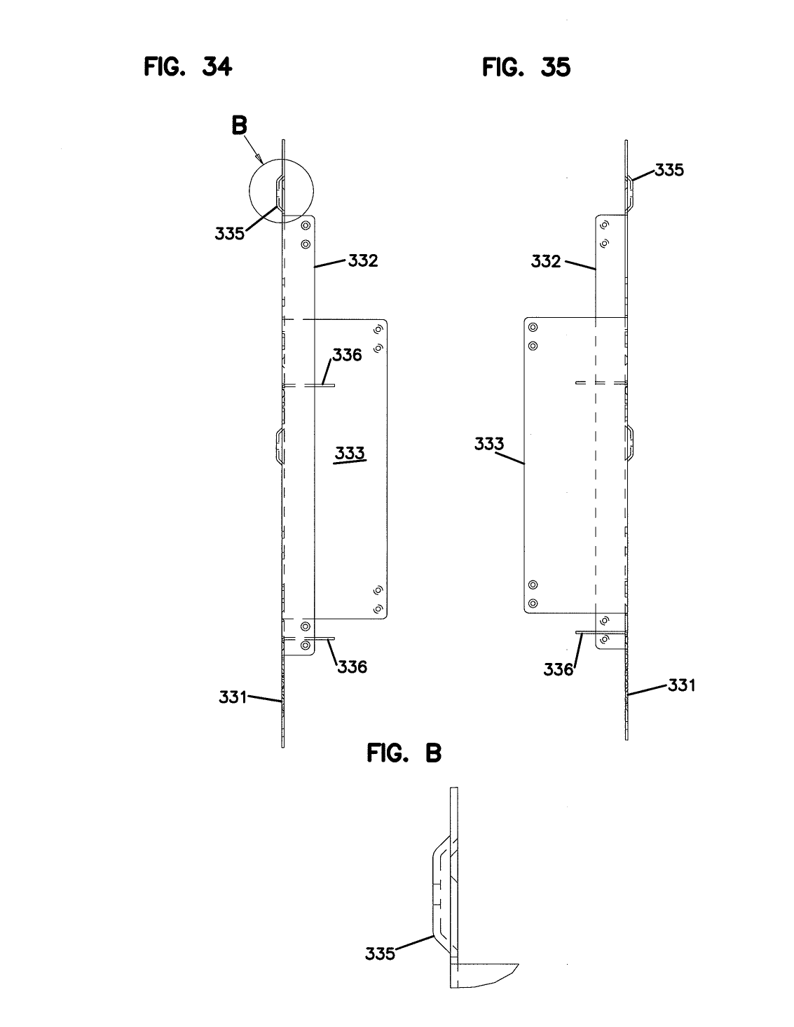

Referring now to FIGS. 18 and 32-36, the support panel 331 of the support frame 330 is configured to hold one or more interface devices (e.g., a splice tray, an adapter module, etc.) to which fibers of the feeder cable 104 can be routed. For example, the support panel 331 can define one or more apertures at which the interface device can be mounted to the panel 331. In the example shown in FIG. 32, the support panel 331 defines two sets 334 of apertures at which at least a first and a second interface device can be mounted.

In accordance with some aspects, each interface device can be pivotally mounted to the support panel 331. For example, the interface device can be mounted so as to enable the interface device to pivot from a non-accessible position to an accessible position. In accordance with certain aspect, pivoting the interface device into the non-accessible position can reduce the footprint of the interface device within the FDH 300 as will be described herein.

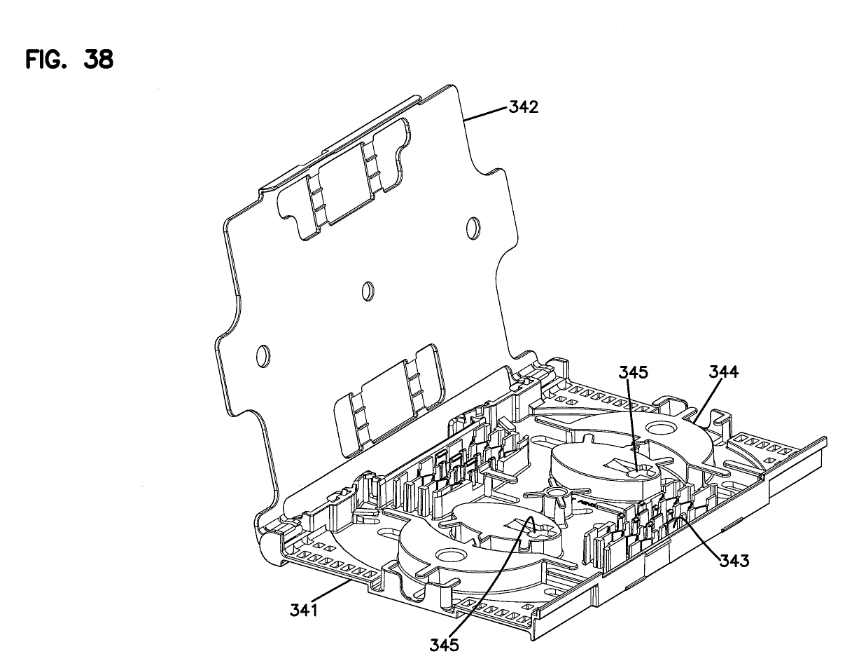

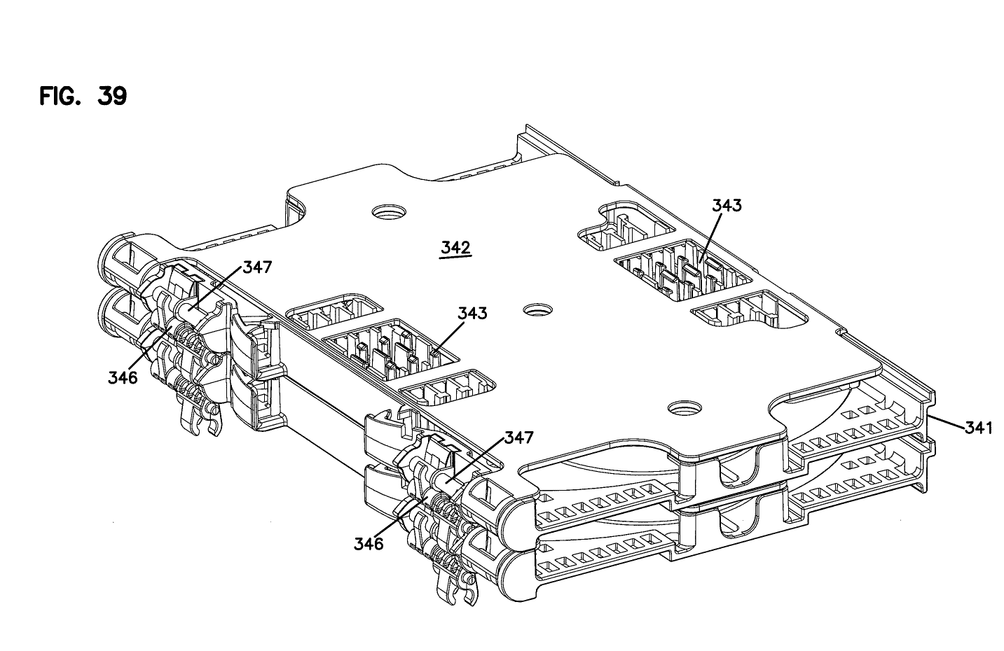

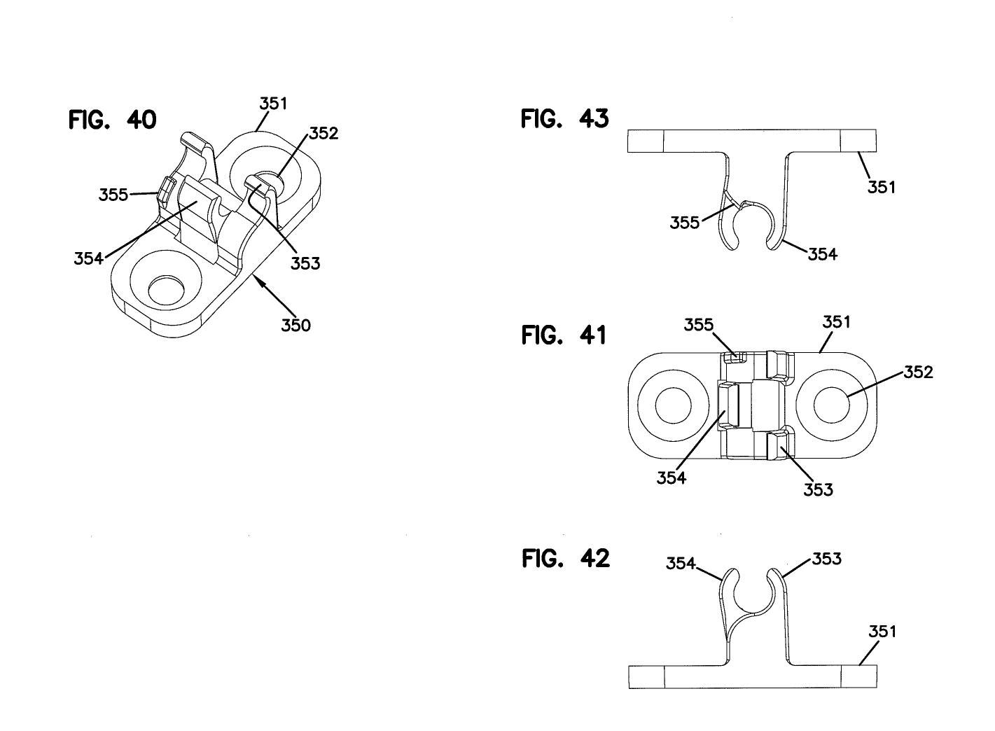

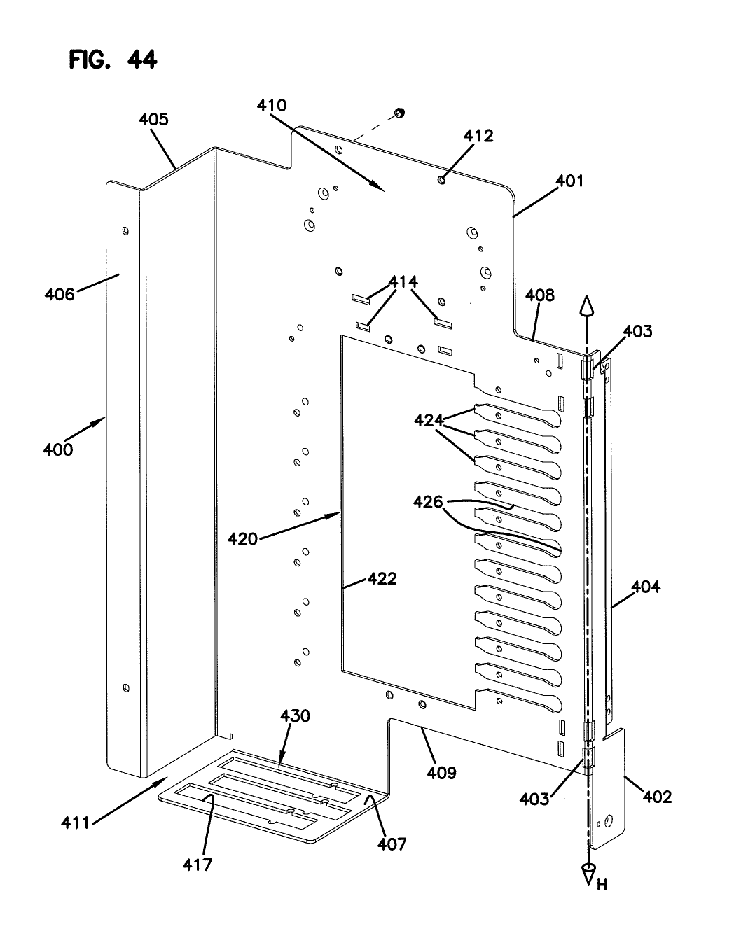

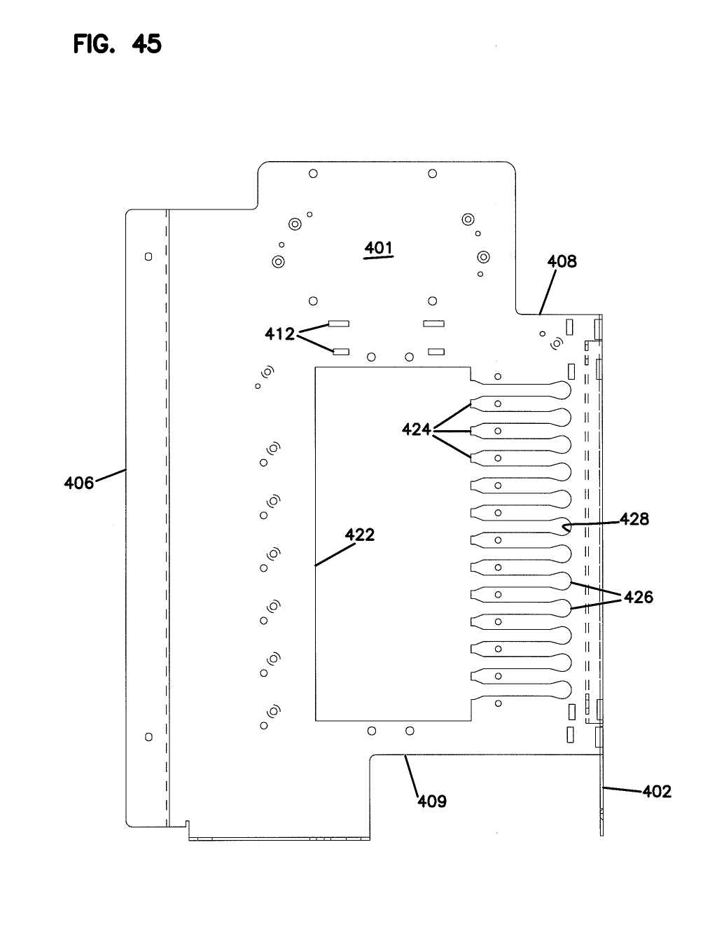

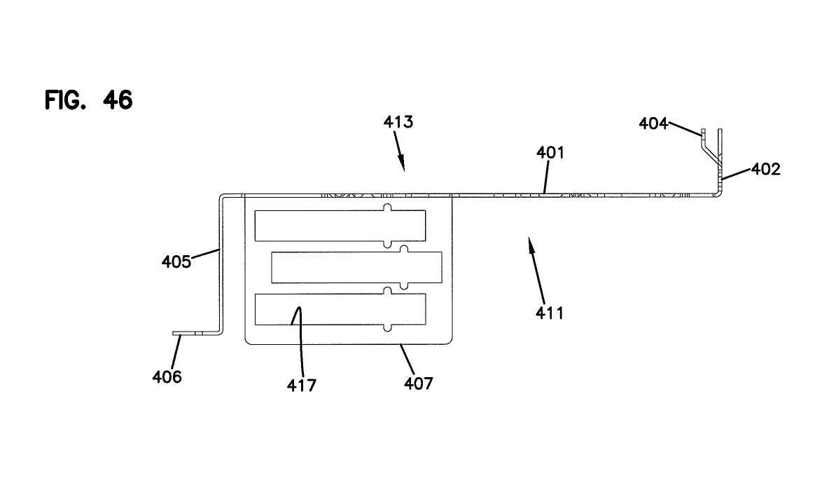

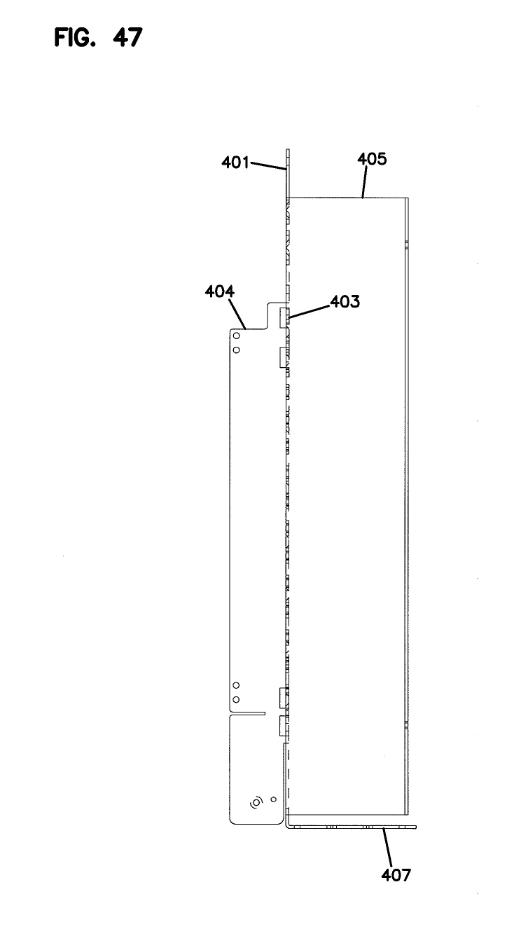

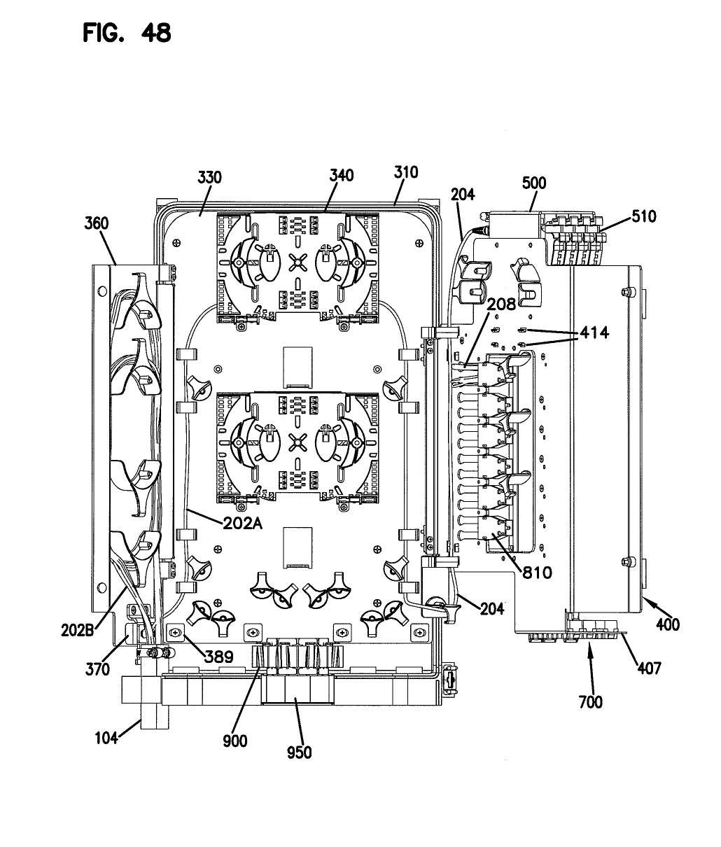

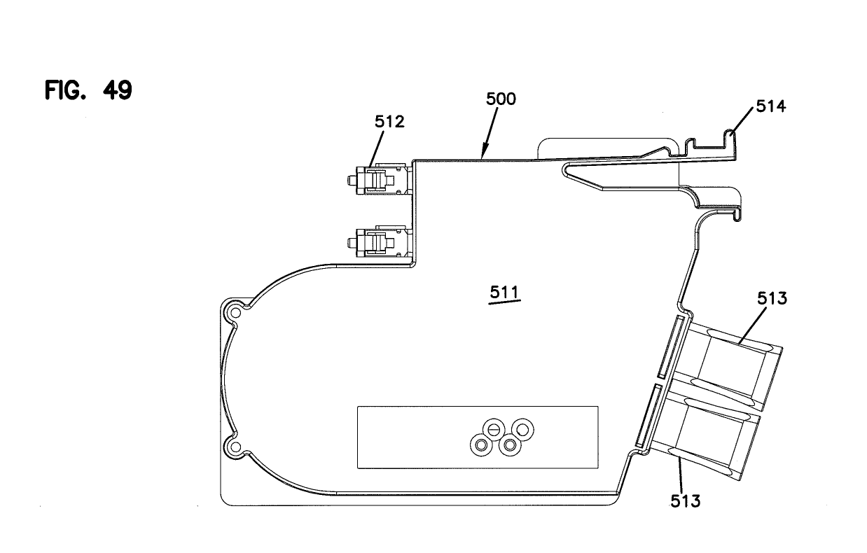

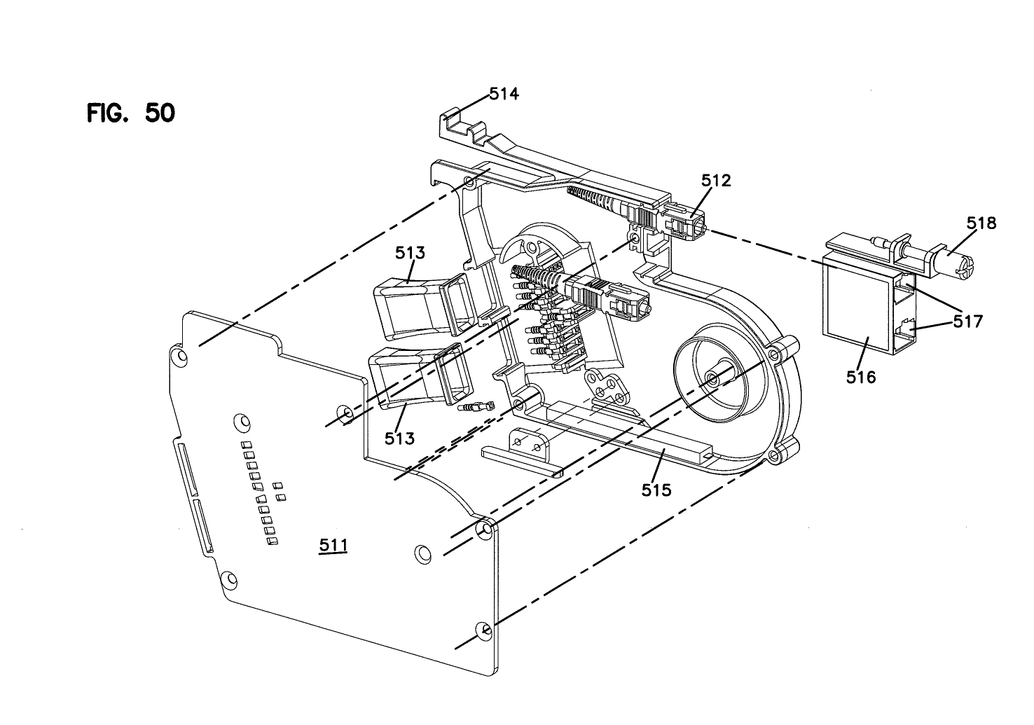

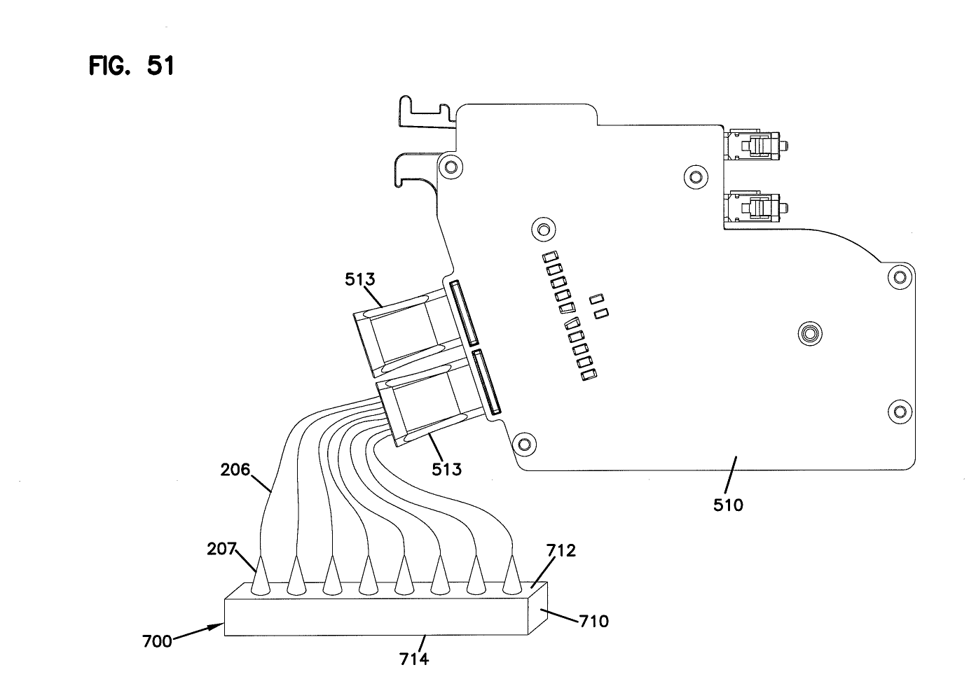

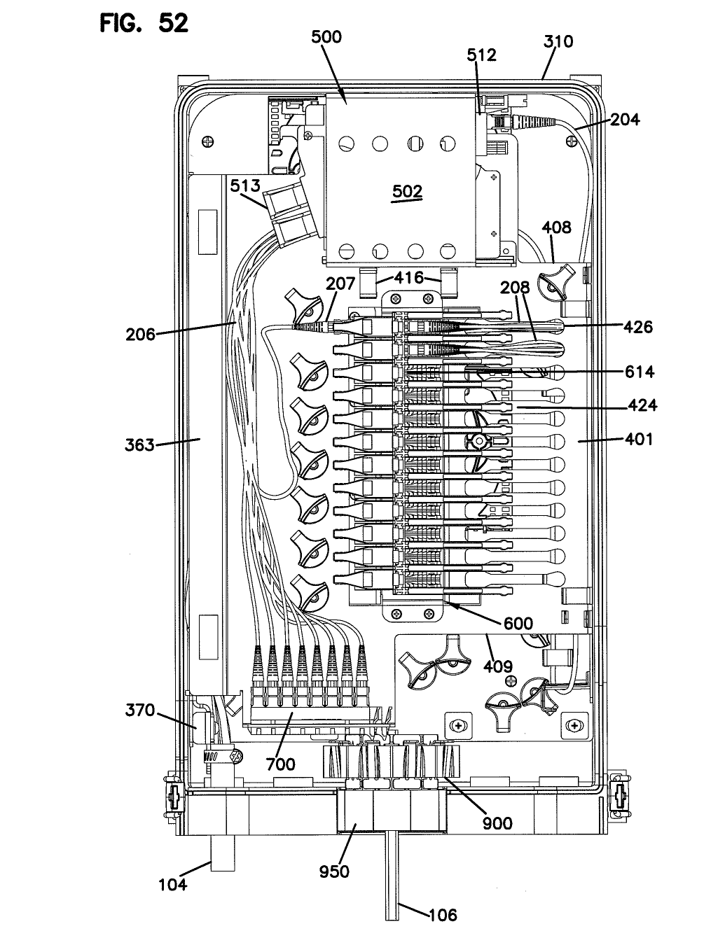

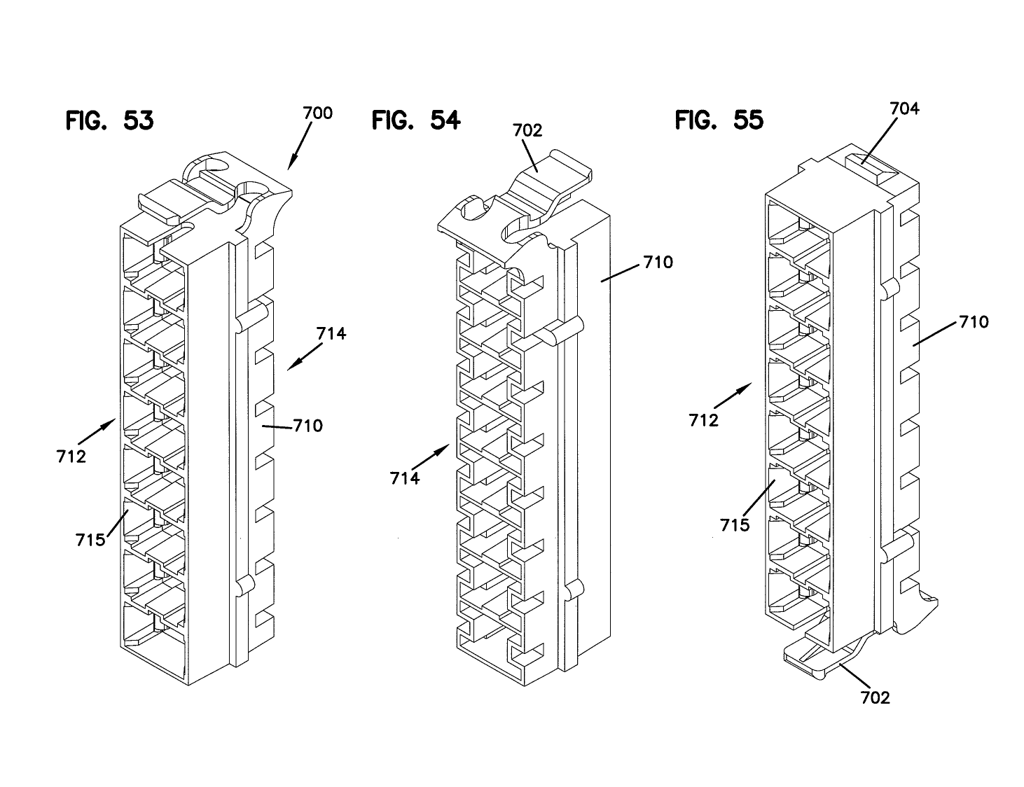

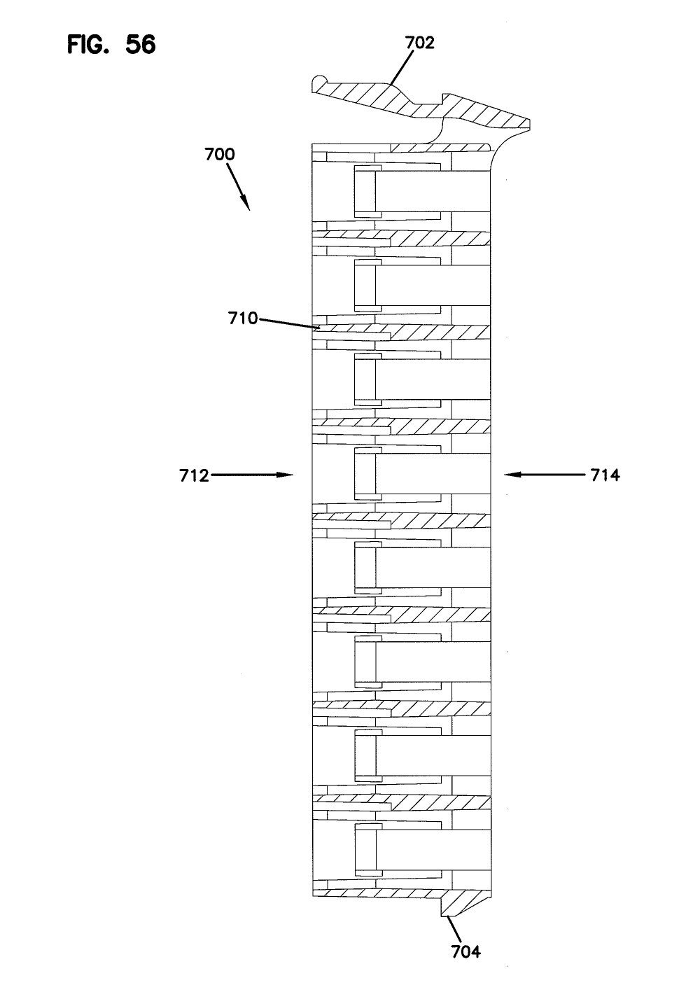

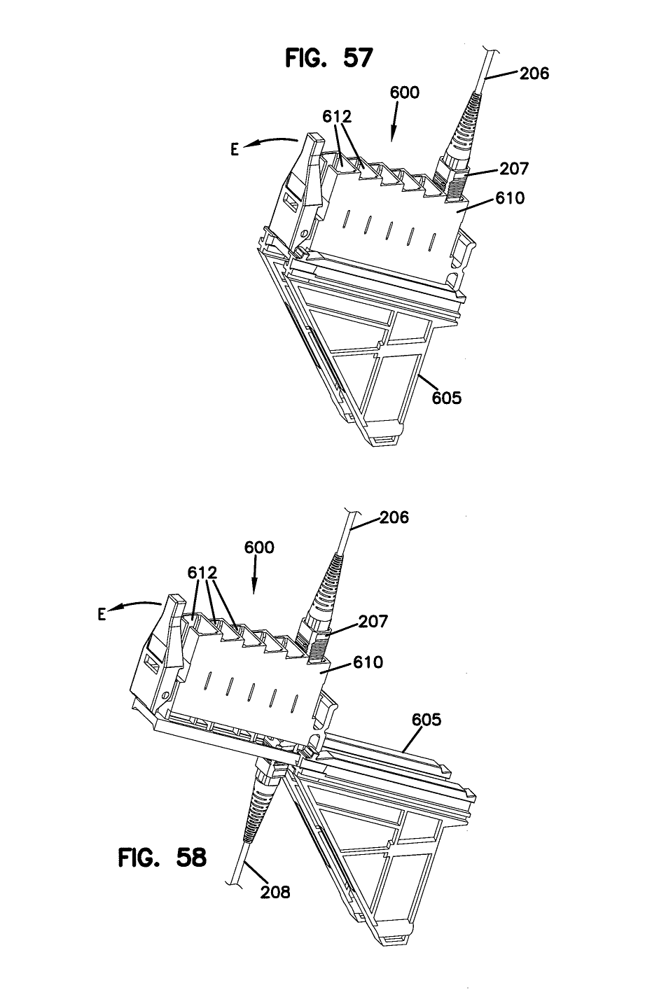

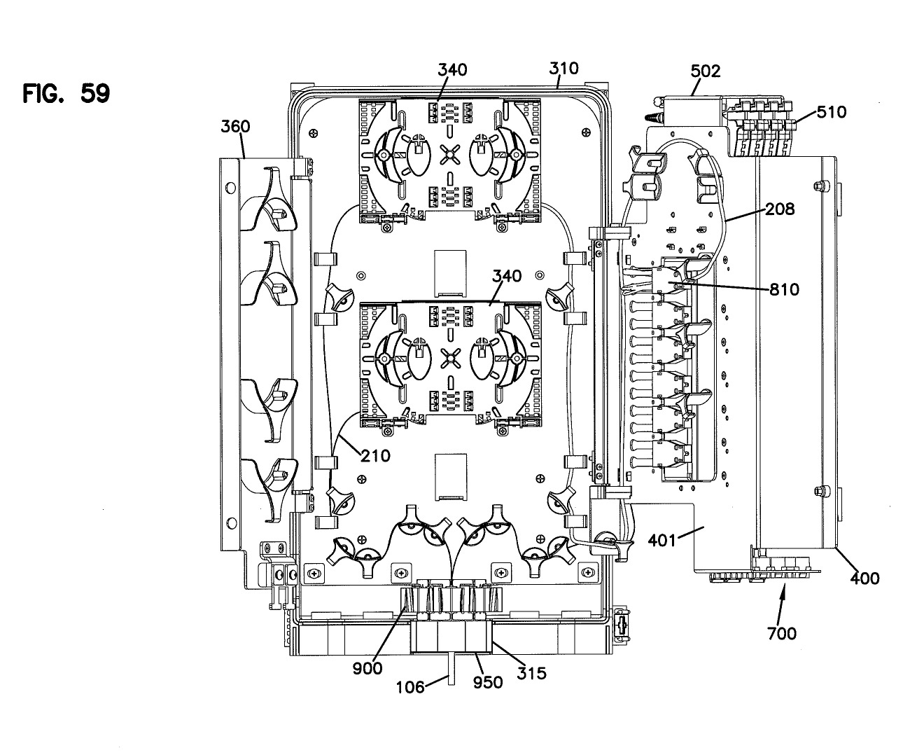

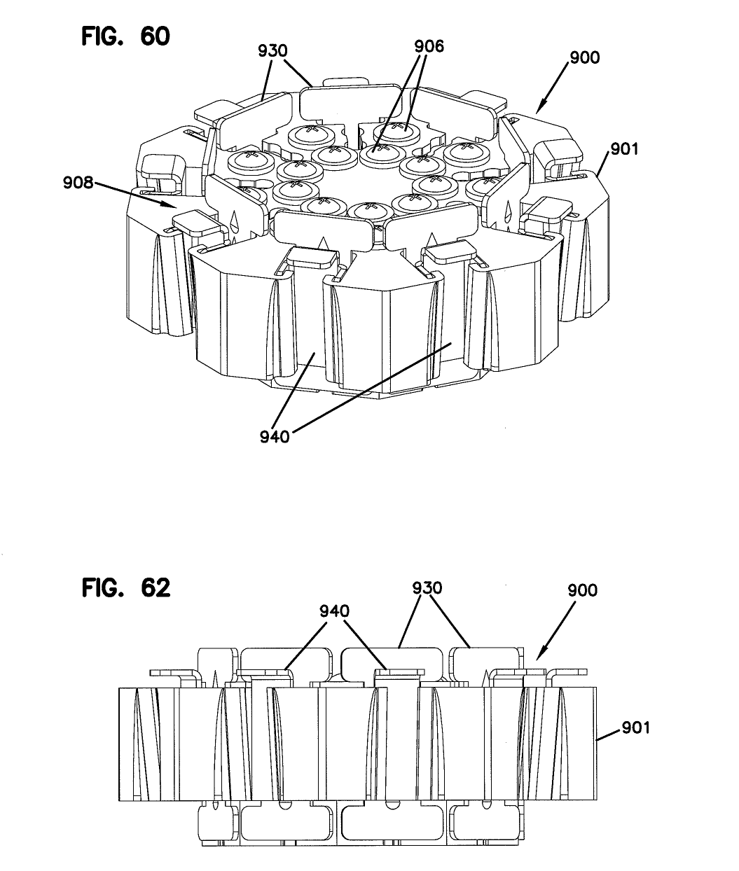

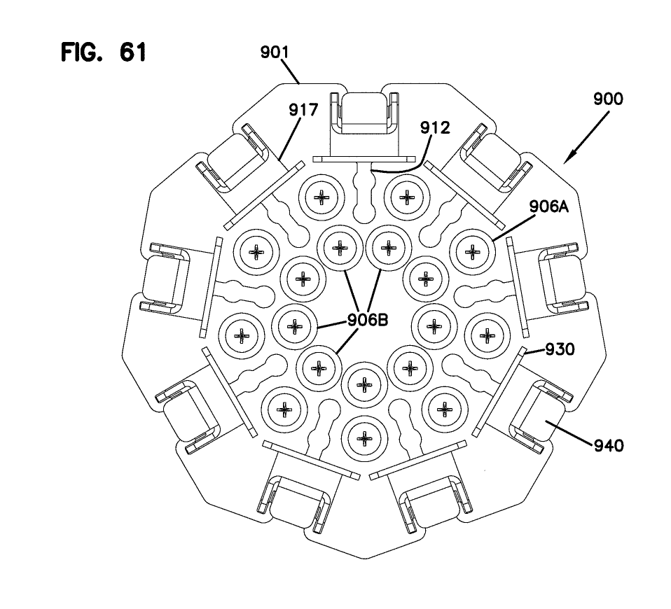

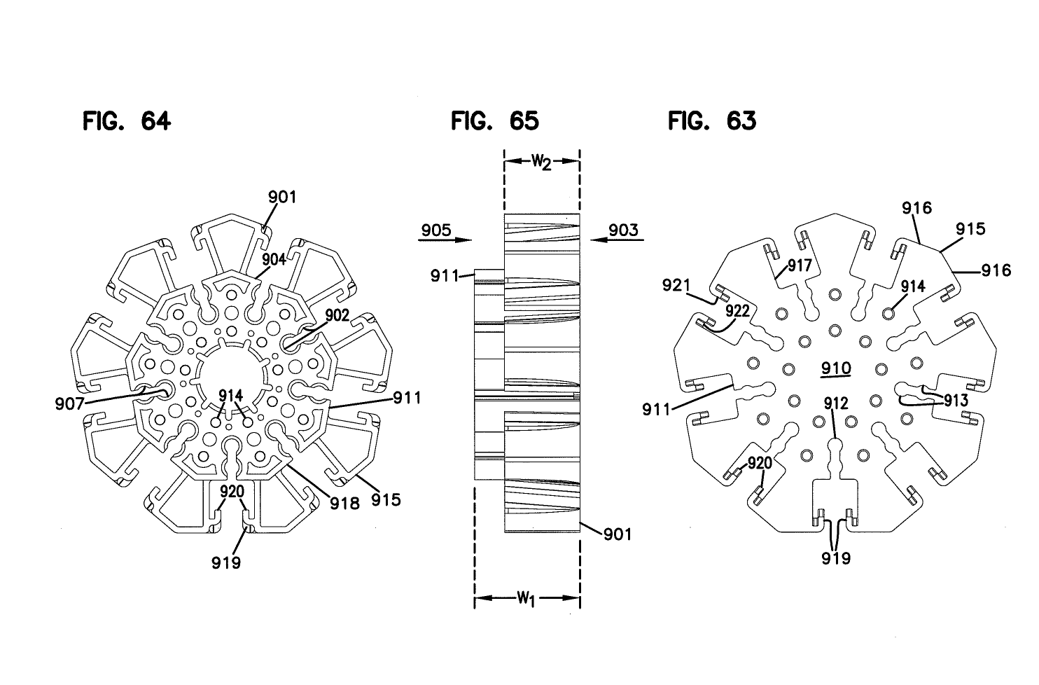

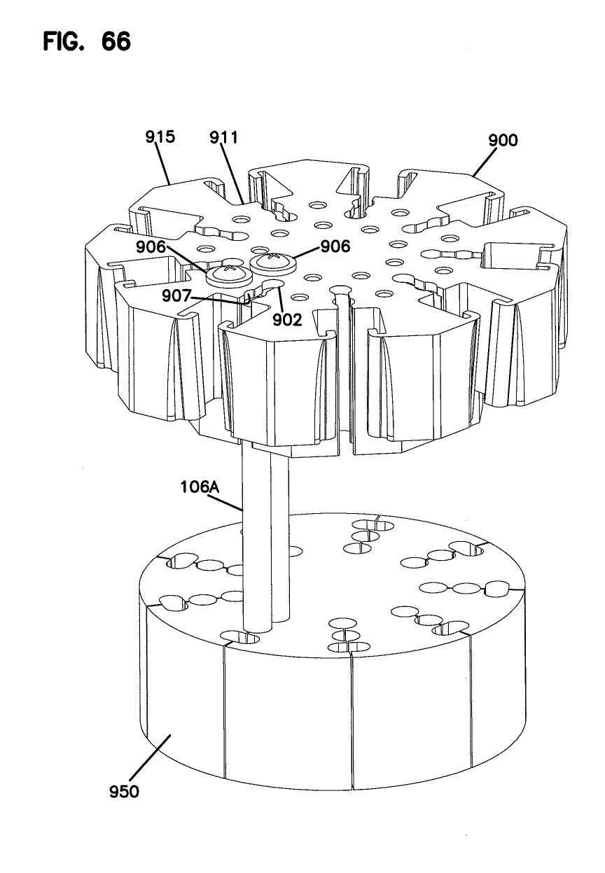

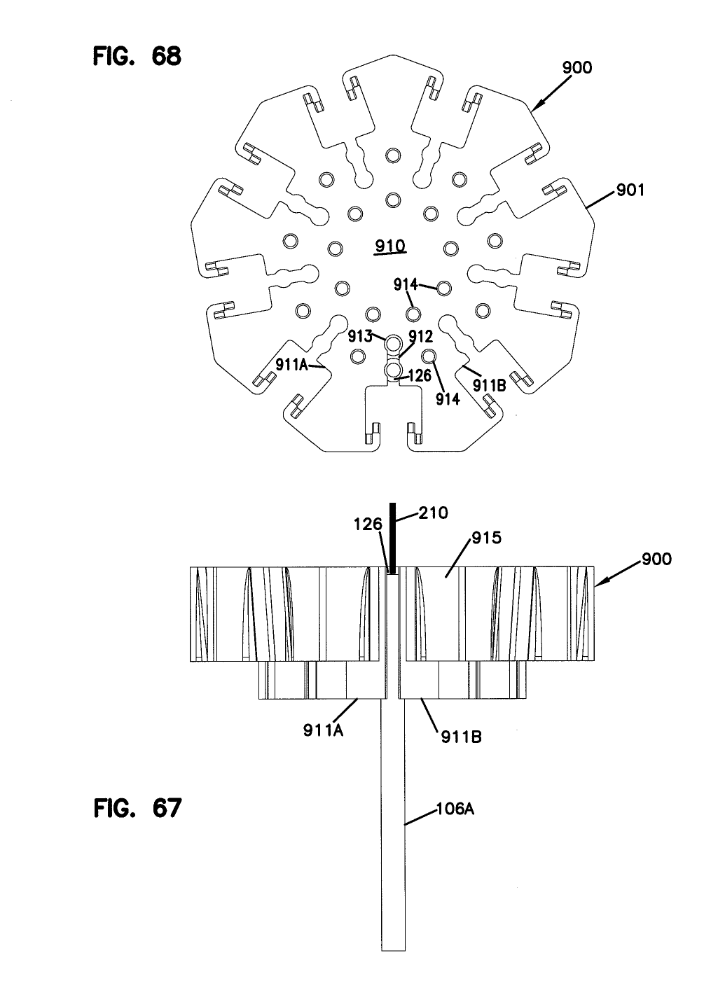

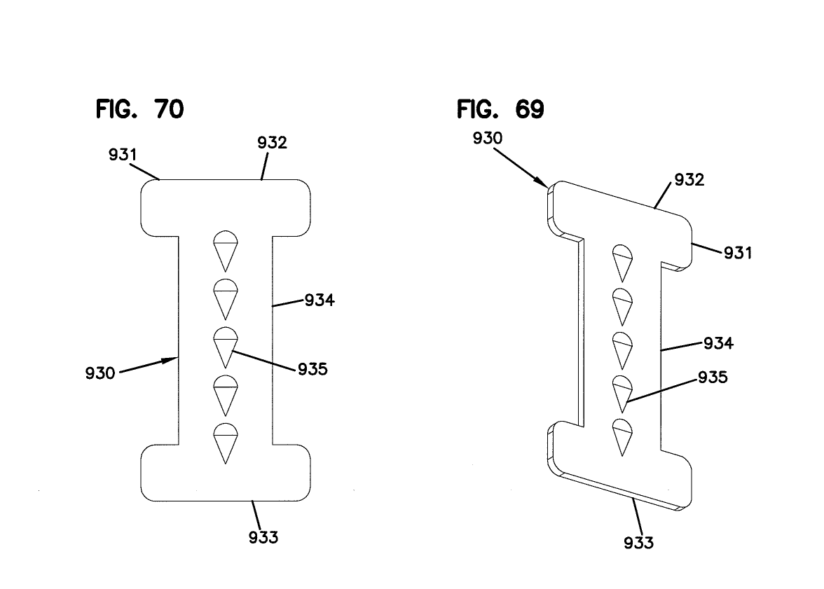

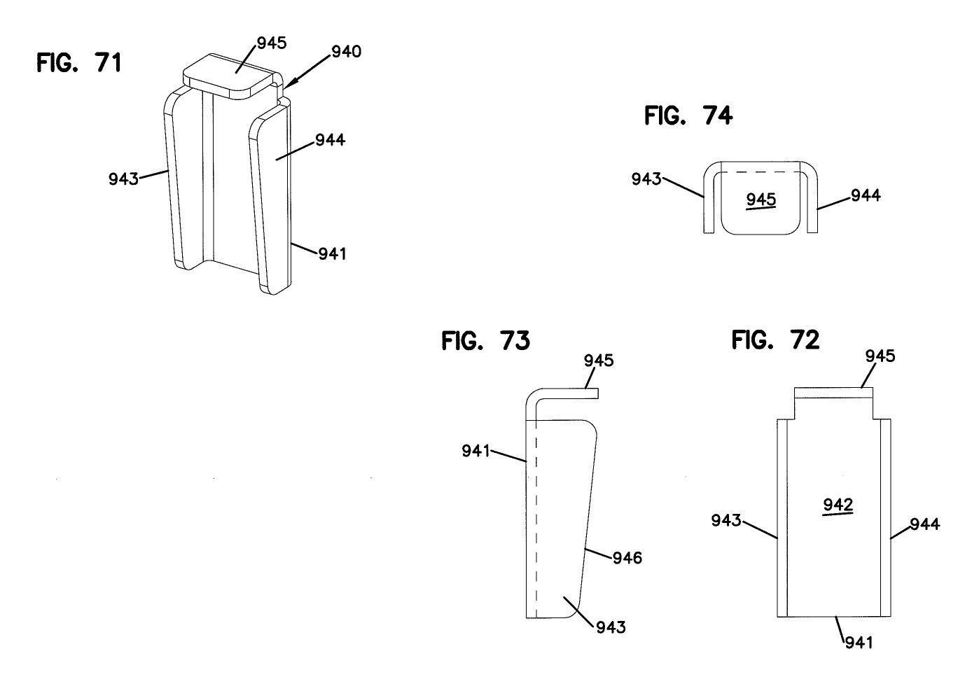

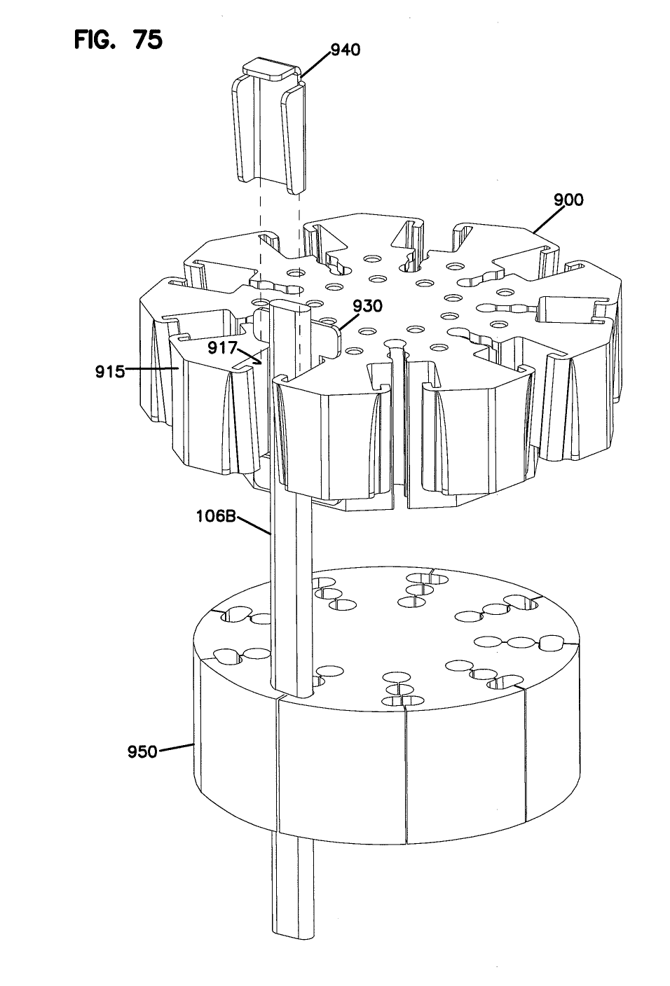

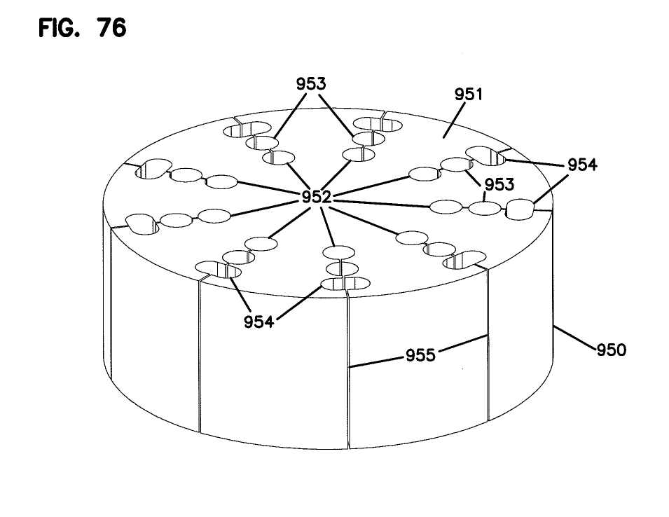

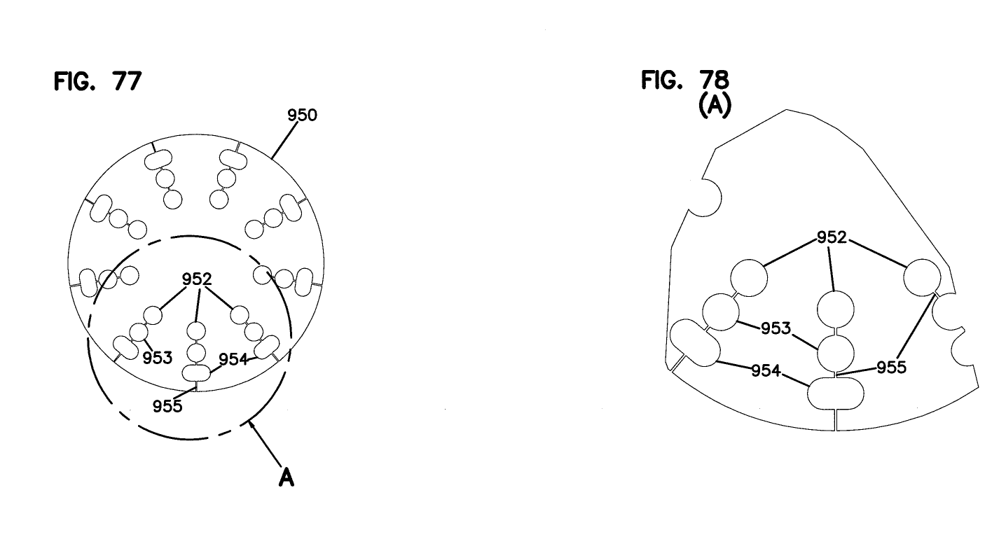

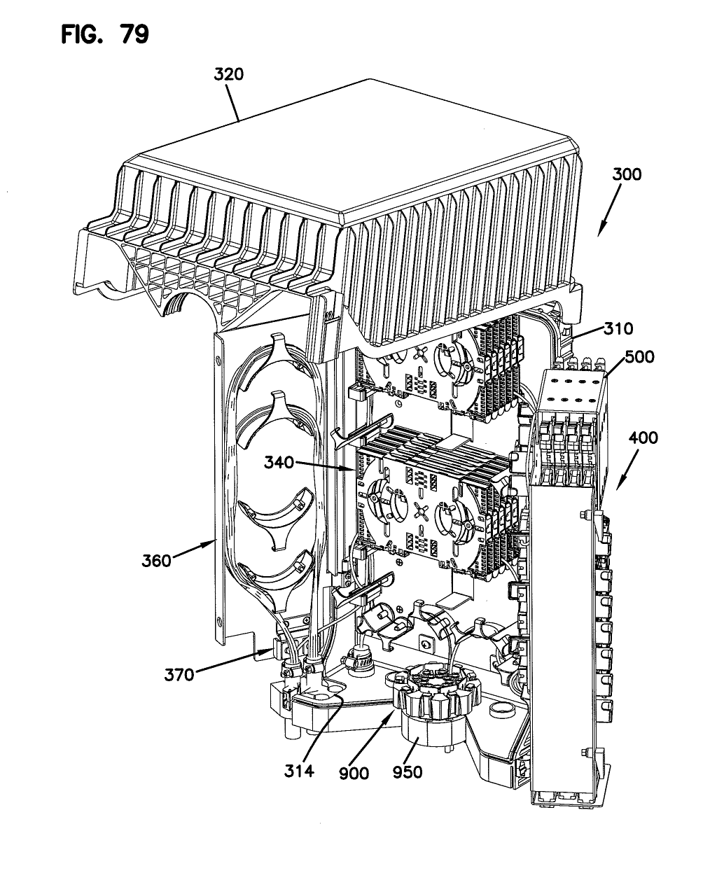

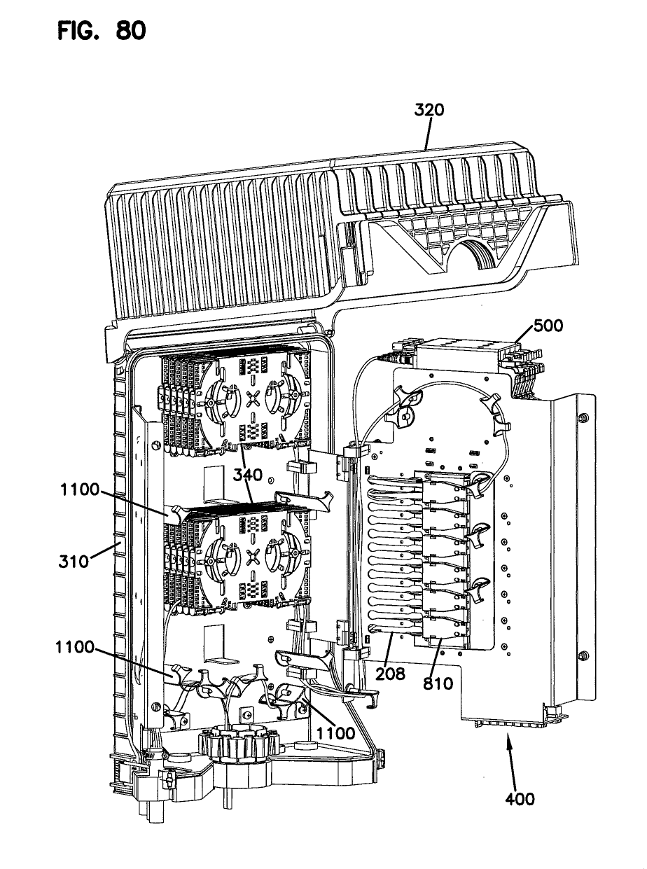

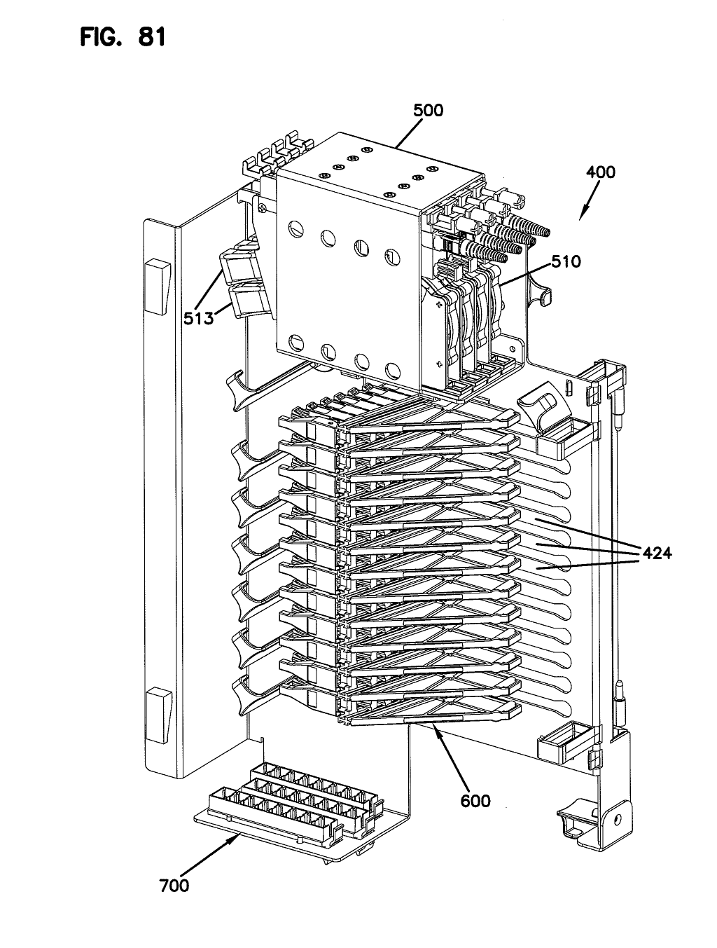

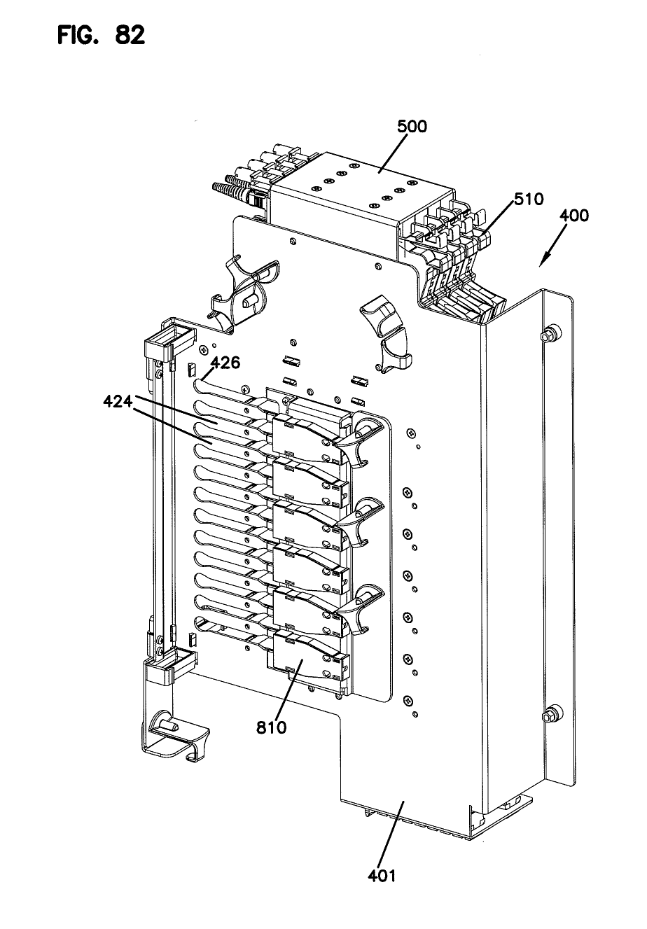

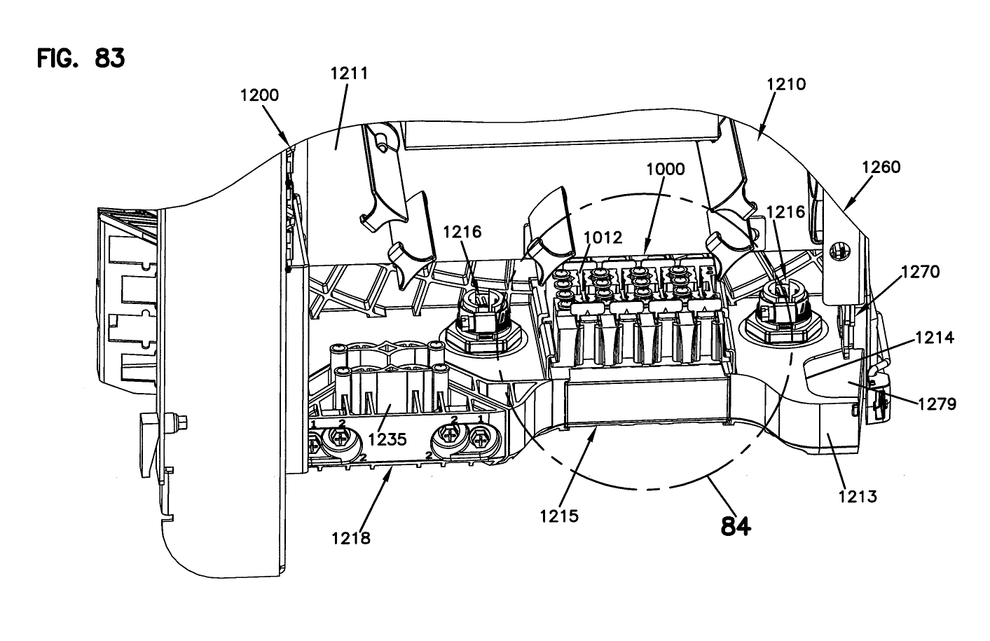

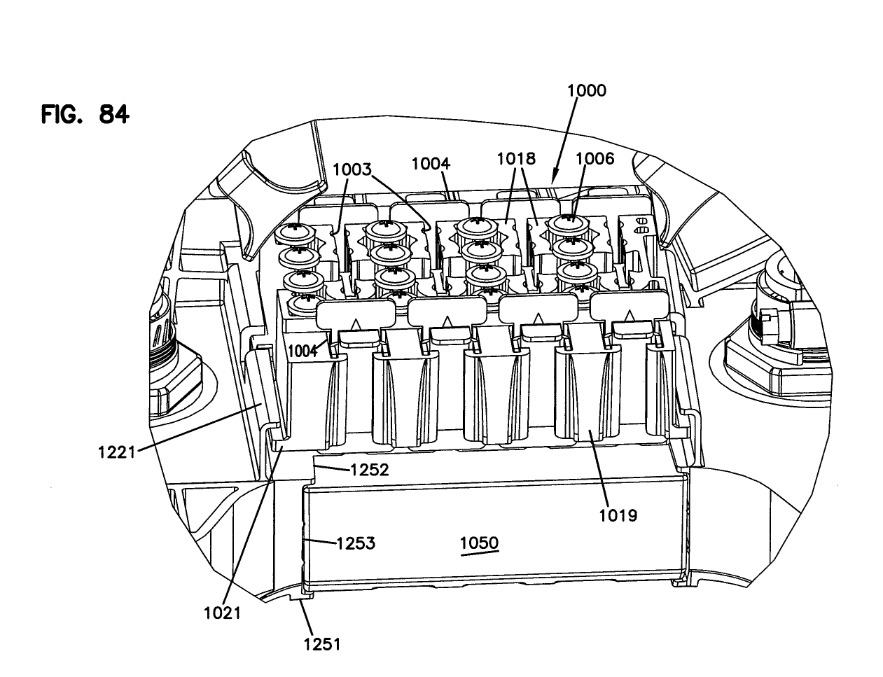

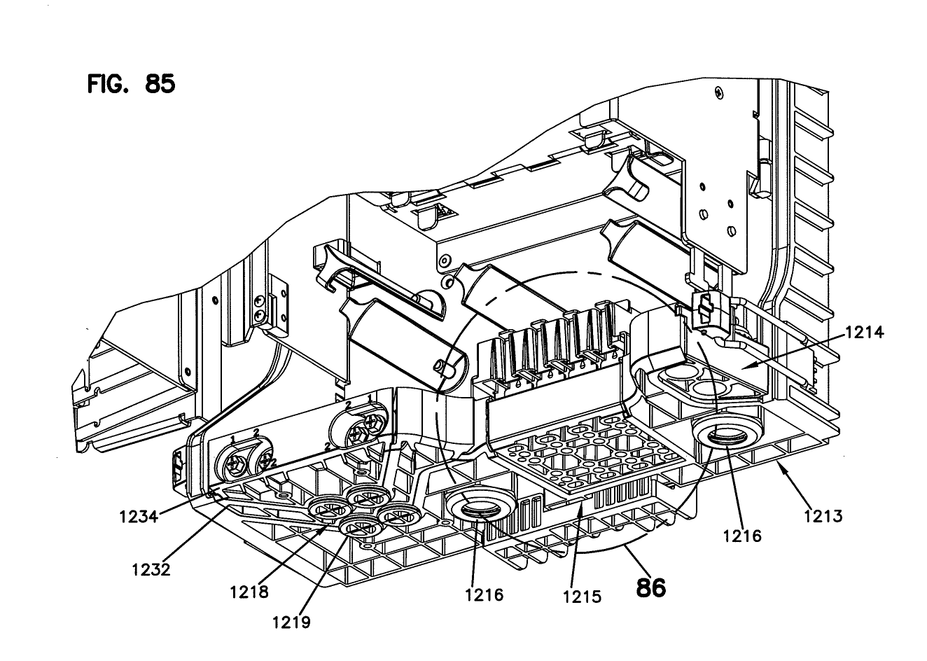

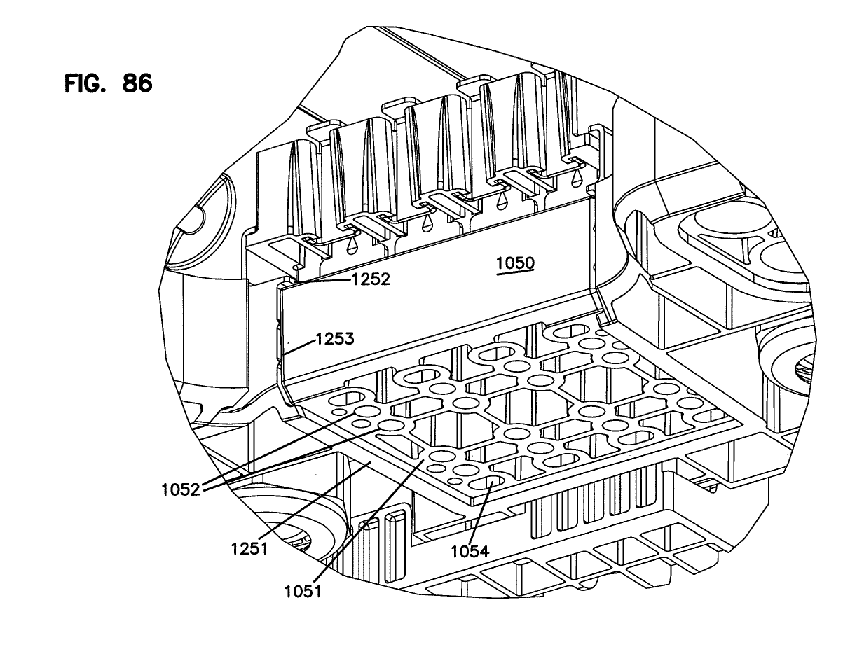

FIGS. 37-39 show an example splice tray 340 suitable for use as an interface device in the FDH 300. The splice tray 340 includes a base tray 341 and a cover 342 that is pivotally mounted to the base tray 341. For example, the cover 342 can be mounted to a pivot rod 347 of the splice tray 340. The base tray 341 defines at least one splice region 343 and at least one fiber management spool 344. In accordance with one aspect, an attachment portion 345 of the splice tray 340 includes a magnet. In the example shown in FIG. 38, each splice tray 340 defines two attachment portions 345, each retaining one magnet (e.g., a disc magnet).

In accordance with certain aspects, one or more splice trays 340 can be pivotally mounted to the support panel 331. For example, each splice tray 340 can be mounted to enabling pivoting of the splice tray 340 between an inaccessible position and an accessible position. When arranged in the accessible position, the cover 342 of the splice tray 340 can be pivoted open to provide access to the splice regions 343 of the splice tray 340. In accordance with some aspects, pivoting the splice tray 340 to the accessible position includes pivoting the splice tray 340 to a generally horizontal position. For example, in FIG. 26, a feeder cable fiber 202A is broken out from a feeder cable 104 and routed up the side of the support panel 331 to a splice tray 340 oriented in an accessible position.

When arranged in the inaccessible position, the cover 342 of the splice tray 340 faces the support panel 331, thereby inhibiting access to the splice tray 340. In accordance with certain embodiments, the splice tray 340 can be retained in the inaccessible position via magnets. For example, the support panel 331 can define at least one magnet mounting station 335 at which a magnet can be mounted. The magnet is configured to interact with the magnet mounted in the splice tray 340 to retain the splice tray 340 in an inaccessible position. In the example shown in FIGS. 18 and 32-36, the support panel 331 defines two magnet mounting stations 335 adjacent each set 334 of mounting apertures. In accordance with one aspect, each of the magnet mounting stations 335 protrudes rearwardly of the support panel 331.

FIGS. 40-43 show an example attachment member 350 suitable for pivotally mounting the splice tray 340 to the support panel 331. The attachment member 350 includes a base 351 defining one or more attachment openings 352 through which a fastener can extend to secure the attachment member 350 to the support panel 331 (e.g., at openings 334 of the support panel 331). The attachment member 350 also includes opposing fingers 353 and 354 that form a snap-fit latch that is sized and configured to rotatably mount to the pivot rod 347 of the splice tray 340. For example, in accordance with one aspect, the opposing fingers 353, 354 of a first attachment member 350 can snap about the pivot rod 357 of the top-most splice tray 340 in the stack and the opposing fingers 353, 354 of a second attachment member 350 can snap about the pivot rod 357 of the bottom-most splice tray 340 in the stack.

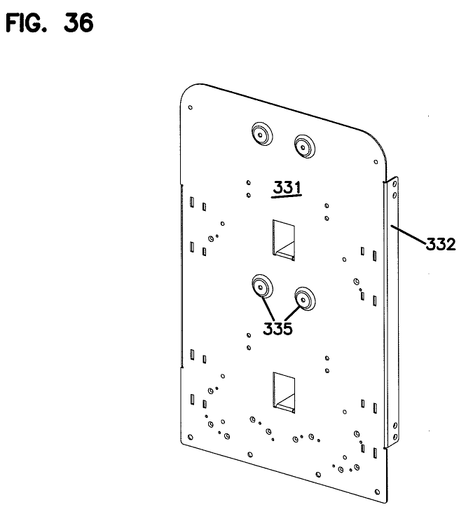

In accordance with some aspect, the attachment member 350 can include a stop 355 that is configured to interact with the respective splice trays 340 to retain the splice tray 340 in the accessible position. In the example shown, the stop 355 protrudes from one of the latching fingers of the attachment member 350. In accordance with other aspects, the support panel 331 can define a tab 336 protruding outwardly from the panel 331 to provide support for the splice tray stack when one of the splice trays 340 is arranged in the accessible position. For example, the tab 336 can be defined by a bent section of the support panel 331 (see FIGS. 18 and 36).

In accordance with certain embodiments, multiple splice trays 340 can be mounted together to form a splice tray stack (see FIG. 39). For example, the splice trays 340 can be pivotally mounted together via an attachment link 346 mounted on the pivot rods 347 of the splice trays 340. In accordance with some aspects, the splice trays 340 of the stack can be oriented in a vertical position for storage so that the cover 342 of the top-most splice tray 340 faces the support panel 331 and the bottom of the bottom-most splice tray faces the cover 320 of the FDH 300. When access to one of the splice trays 340 is desired, an appropriate portion of the stack can be pivoted so that the splice tray 340 to be accessed is oriented generally horizontally.

Additional information about an example splice tray 340 and an example attachment link 346 suitable for use in the example FDH 300 can be found in copending and commonly assigned application Ser. No. 12/425,241, filed Apr. 16, 2009, entitled “Fiber Optic Splice Tray,” the disclosure of which is hereby incorporated by reference herein.

FIGS. 44-47 show an example swing frame 400 that is suitable for use in the example FDH 300. A number of telecommunications components can be mounted on the swing frame 400. In the example shown, a splitter mounting location 410 for mounting fiber optic splitter modules 510 (FIGS. 49-51) is located adjacent the top of the swing frame 400. A termination field 420 is located beneath the splitter mounting location 410. A connector storage location 430 is positioned beneath the termination field 420 on the swing frame 400. Cable/fiber management structures also can be provided throughout the swing frame 400. In other embodiments, however, the telecommunication components can be mounted to the swing frame 400 in different configurations.

In the example shown, the swing frame 400 includes a main panel 401 having a first side 411 and a second side 413. The main panel 401 is pivotally coupled to a side panel 402 along a hinge axis H. In the example shown in FIG. 44, two spaced-apart hinge members 403 pivotally couple the main panel 401 to the side panel 402 along the hinge axis H. An attachment member 404 is coupled to the side panel 402. The attachment member 404 attaches to the second side member 333 of the support frame 330 to mount the swing frame 400 to the support frame 330. Accordingly, the main panel 401 of the swing frame 400 is pivotally coupled to the support panel 331 of the support frame 330.

The main panel 401 also includes another side panel 405 and a flange 406 extending from the side panel 405. In the example shown, the flange 406 includes a bent section of the side panel 405. A bottom panel 407 extends outwardly from the first side 411 of the main panel 401 in a generally orthogonal direction. In accordance with one aspect, the bottom panel 407 is oriented horizontally. In the example shown, the bottom panel 407 is a bent section of the main panel 401.

The main panel 401 defines an opening 422 at the termination region 420 that extends from the first side 411 to the second side 413. Fingers 424 extend into the opening 422 to define slots 426 adjacent the first side panel 402. In accordance with one aspect, each slot 426 defines an enlarged section 428 at an opposite side of the slot 426 from the opening 422. The main panel 401 also defines a first cutout 408 at a top of the main panel 401 adjacent the side panel 402 and a second cutout 409 at a bottom of the main panel 401 adjacent the side panel 402.

In accordance with some aspects, the splitter region 410 of the swing frame 400 is provided at the top of the main panel 401. For example, the main panel 401 can define openings 412 through which fasteners can extend to aid in securing a splitter module bay 500 to the first side 411 of the main panel 401. The splitter module bay 500 includes a housing configured to receive one or more splitter modules 510. The main panel 401 also can provide openings 414 via which one or more support flanges 416 can be attached to the main panel 401 to provide structural support for a splitter module bay 500 (see FIGS. 48 and 52).

The splitter bay 500 and splitter modules 510 have a plug-and-play configuration. In this configuration, the fiber optic splitter modules 510 containing fiber optic splitters 515 (FIG. 50) are inserted into the splitter bay 500 and optically connected to splitter input fibers 204 (i.e., or to feeder fibers 202). For example, each splitter module 510 can be secured to the bay 500 via a latch 514. One or more fiber optic adapters 516 can be coupled to the splitter bay 500 (e.g., via a fastener 518). A fiber optic connector 512 mounted on a fiber optic splitter module 510 plugs into a first port of one of the adapters 516.

A connectorized end of one of the splitter input fibers 204 (i.e., or a feeder cable fiber 202) plugs into an opposite port 517 of the adapter 516 to couple the splitter input fiber 204 to the splitter 515 arranged within the fiber optic splitter module 510. For example, as shown in FIG. 48, one or more splitter input fibers 204 can be routed from one or more splice trays 340, down the support panel 330, up the second side 413 of the swing frame 400, and through the first cutout 408 to the adapter 516. In accordance with one aspect, the splitter input fibers 204 are routed up the swing frame 400 adjacent the hinge axis H of the swing frame 400.

Within the splitter modules 510, the signals from the input fiber 204 are split at the splitter 515 and directed into a plurality (e.g., 8, 16, 32, etc.) of splitter pigtails 206. The splitter pigtails 206 exit the body of the splitter module 510 via one or more exit members (e.g., boots) 513 provided on a side of the splitter module 510. In accordance with some aspects, at least two splitter pigtails 206 extend through each exit member 513. For example, in accordance with some aspects, at least four splitter pigtails 206 extend through each exit member 513. In accordance with certain aspects, at least eight splitter pigtails 206 extend through each exit member 513. In accordance with certain aspects, at least sixteen splitter pigtails 206 extend through each exit member 513.

Splitter modules 325 and plug and play arrangements similar to those shown herein are described in greater detail in commonly owned U.S. Pat. Nos. 7,376,322; 7,400,813; 7,376,323; and 7,418,181, the entire disclosures of which are incorporated herein by reference.

As shown in FIG. 52, the splitter pigtails 206 are routed laterally away from the splitter modules 510 and then downwardly along a vertical cable management channel on the first side 411 of the swing frame 400. The ends of the pigtails 206 include fiber optic connectors 207. Some of the pigtails 206 are routed downwardly and then looped back upwardly and plugged into the adapters or adapter modules in the termination field 420 so as to be optically connected to another optical fiber (e.g., a fiber 208, 210 corresponding to an end user 109). Example termination adapter modules will be described in greater detail herein.

Other connectorized pigtails 206 can be routed downwardly along the vertical cable management channel and stored at the connector storage module 700. The connector storage modules 700 are adapted for storing and protecting the connectorized ends 207 of the splitter pigtails 206 when the splitter pigtails 206 are not connected to the termination field 420. In accordance with certain aspects, the pigtail connectors 207 of each splitter module can be stored initially in one or more storage modules 700 (e.g., see FIGS. 51 and 52).

The connector storage module 700 is configured be mounted to the bottom panel 407 of the swing frame 400. Each connector storage module 700 includes a body 710 defining a snap-fit connection mechanism to secure the body 710 to an opening of the bottom panel 407. For example, in the example shown in FIGS. 53-56, the storage module body 710 defines a latch 702 and a catch 704 that cooperate with openings 417 defined in the bottom panel 407. In accordance with other aspects, other types of connection mechanisms can be utilized.

In accordance with one aspect, the storage module body 710 is configured to receive the connectorized ends 207 when dust caps are mounted over ferrules of the connectorized ends 207. In accordance with another aspect, a connector storage module body 710 includes an integral (one-piece) housing 710 defining openings 715 leading to an interior in which the connectorized ends 207 can be stored. In accordance with another aspect, the storage module body 710 is made from plastic. Further details regarding example embodiments of the connector storage modules 700 can be found in U.S. Pat. Nos. 7,277,620 and 7,198,409, which are hereby incorporated by reference.

The termination field 420 includes a plurality of termination modules 600 that are disposed on the swing frame 400. In accordance with some aspects, the termination field 420 can include a vertical column of termination modules 600. In the example shown in FIG. 52, a plurality of termination modules 600 are arranged in a column on the first side 411 of the swing frame 400. The termination modules 600 extend over the opening 422 defined by the main panel 401 of the swing frame. In accordance with other aspects, however, the termination field 420 can include a plurality of adapters extending through the opening 422 from the first side 411 of the main panel 401 to the second side 413.

FIGS. 57 and 58 show an example termination module 600 that includes an adapter module 610 mounted to a base 605. The adapter module 610 defines a horizontal row of at least one fiber optic adapter (e.g., a row of 6 fiber optic adapters). Each of the fiber optic adapters of the adapter module 610 includes a first port 612 facing toward the second side wall 405 of the swing frame 400 for receiving a fiber optic connector (e.g., connector 207 terminating one of the splitter pigtails 206). Each of the fiber optic adapters also includes a second port 614 facing toward the first side wall 402 of the swing frame 400 for receiving a fiber optic connector (e.g., connector 209 terminating one of the fibers 208). As is known in the art, each fiber optic adapter is configured to provide an optical coupling between the fiber optic connectors inserted into the ports 612, 614.

In accordance with some aspects, the adapter modules 610 are moveable (e.g., slideable) relative to the base 605 between a retracted position (FIG. 57) and an extended position (FIG. 58). For example, in the example shown in FIG. 52, sliding one of the adapter modules 610 to the extended position slides the adapter module 610 away from the first side 411 of the main panel 401 of the swing frame 400. Sliding the adapter module 610 to the refracted position slides the adapter module 610 toward the first side 411 of the main panel 401 of the swing frame 400. The retractable/extendable configuration of the adapter modules 610 facilitates accessing the densely populated termination field 420. Moving one of the adapter modules 610 into the extended position provides enhanced access to the ports 612, 614 of the extended adapter module 610 and, accordingly, provides enhanced access to the connectors 207, 209 plugged into the ports 612, 614. Similar sliding adapter modules are described in greater detail in commonly owned U.S. Pat. Nos. 5,497,444; 5,717,810; 6,591,051; and 7,416,349, the disclosures of which are incorporated herein by reference.

As noted above, the termination field 420 optically couples the splitter pigtails 206 to subscriber lines 208. The subscriber lines 208 are routed from the termination field 420 on the swing frame 400 to one or more interface devices, such as splice trays 340, on the support frame 330. In accordance with certain aspects, the subscriber lines 208 can be ribbonized at one or more fanouts 810 between the termination field and the interface devices. For example, in accordance with some aspects, one or more fanouts 810 can be provided on the second side 413 of the main panel 401 of the swing frame 400. The ribbonized cable can be routed to the interface device to be optically coupled to an output cable 106.

In the example shown in FIG. 59, six fanouts 810 are provided on the second side 413 of the main panel 401 of the swing frame 400 adjacent the slots 426. In accordance with other aspects, however, greater or fewer fanouts 810 can be provided. In accordance with other aspects, the fanouts 810 can be provided at a different location of the swing frame 400 or on the support frame 330. In accordance with one aspect, each subscriber line 208 extends from the adapter module 610, through one of the slots 426 defined in the main panel 401 to pass from the first side 411 of the swing frame 400 to the second side 413, and to one of the fanouts 810. A ribbonized cable of multiple subscriber lines 208 extends from the fanout 810, loops around at the top of the swing frame 400, extends down the second side 413 of the main panel 401 along the hinge axis H, and loops back up onto the support panel 330 toward one of the splice trays 340.

One or more output fibers 210 enter the FDH 300 at the output cable port 315 and extend to the interface device at which the output fibers 210 can be optically coupled to the subscriber lines 208. In accordance with some embodiments, the output fibers 210 can be separated from the cable jackets and strength members of the respective output cables 106 at a cable manager 900 that is provided at the cable port 315 (e.g., see FIGS. 52 and 59). In accordance with certain aspects, the cable manager 900 secures the output cables 106 to the FDH 300.

FIGS. 60-75 illustrate one example cable manager 900 suitable for use with the FDH 300. The cable manager 900 includes a body 901 having a first side 903 and an opposite second side 905. The body 901 defines at least one slot extending through the body 901 from the first side 903 to the second side 905. The slot is configured to enable fibers 210 of at least one output cable 106 to pass through the body 901. Typically, the cable manager 900 includes multiple slots through which the output fibers 210 can pass.

In accordance with some aspects, the cable manager 900 is configured to receive multiple types of output cables 106. In accordance with one aspect, the cable manager 900 can be configured to receive round output cables 106A and flat output cables 106B. For example, the body 901 of the cable manager 900 can define slots 902 configured to accommodate fibers of round output cables 106A and can define slots 904 configured to accommodate fibers of flat output cables 106B. In the example shown in FIG. 61, the cable manager 900 is configured to receive up to eighteen round cables and up to nine flat cables. In accordance with other aspects, however, the cable manager 900 can be configured to receive any desired type of cable.

Referring to FIGS. 60-65, the body 901 of the cable manager 900 includes a first set of arms 911 extending outwardly from a hub 910. Each pair of adjacent arms 911 defines a slot 912 therebetween. Each slot 912 defines at least one enlarged section 913 sized and configured to accommodate the passage of fibers of a round cable 106A. In the example shown, each slot 912 defines two such enlarged sections 913 spaced along a length of the slot 912. In accordance with one aspect, the first side 903 of the body 901 can define a shoulder 907 at each enlarged section 913.

The body 901 also includes strength member tie-downs 906 at which strength members (e.g., aramid yarn) of the output cables can be secured. For example, the body 901 can define multiple openings 914 configured to receive tie-down fasteners (e.g., screws). In the example shown, a first strength tie-down 906A can be provided on each arm 911. Second strength member tie-downs 906B are provided on the hub 910 spaced inwardly from each of the first tie-downs 906A. In use, strength members of the output cables can be wrapped around and secured by a fastener mounted at one of the tie-downs 906.

FIGS. 66-68 illustrate two round output cables 106A being mounted to the example cable manager 900. The body 901 of the cable manager 900 includes a pair of adjacent arms 911A, 911B that define a slot 912 therebetween. As shown in FIG. 67, a jacket 126 of the output cable 106A is stripped from fibers 210. An edge of the jacket 126 seats against the shoulder 907 of each enlarged section 913. Accordingly, unjacketed fibers 210 of the output cable 106A extend upwardly from the cable manager 900 and into the FDH 300.

Referring back to FIGS. 60-65, a second set of arms 915 extend outwardly from the first set of arms 911 at the first side 903 of the body 901. The arms 915 of the second set have a width W₂ that is less than a width W₁ of the body 901. The arms 915 define ramped external surfaces 916 that are configured to aid insertion of output cables 106 into the cable manager body 901. Each adjacent pair of arms 915 defines a receiving channel 917 therebetween that is sized and configured to accommodate the passage of a flat output cable 106B.

In accordance with certain embodiments, the receiving channels 917 are configured to accommodate retention members 908 that are configured to aid in the securement of flat output cables 106B to the cable manager 900. For example, each receiving channel 917 can be configured to accommodate a cable stay and a wedge (see FIG. 60). In the example shown, each receiving channel 917 extends outwardly from shoulders 918 defined by adjacent arms 911 to flanges 919. The shoulders 918 are configured to accommodate the cable stays and the flanges 919 are configured to accommodate the wedges.

In accordance with some aspects, each arm 915 includes a flange 919 extending laterally outwardly from each side. Accordingly, each pair of adjacent flanges 919 defines a reduced section 921 of the receiving channel 917. Each flange 919 also bends back toward the hub 910 to define a notch 922 between the flange 919 and the respective second arm 915.

FIGS. 69 and 70 show one example cable stay 930 suitable for retaining a flat output cable 106B in combination with a wedge as will be described herein. The example cable stay 930 includes a generally flat body 901 extending between a first end 932 and a second end 933. The body 901 includes an intermediate section 934 having a reduced width relative to the ends 932, 933. Catches 935 are arranged along the intermediate section 934. When the cable stay 930 is arranged in the cable manager 900, each catch 935 is configured to dig partially into the jacket of an output cable to inhibit pullout of the output cable.

FIGS. 71-74 show one example wedge 940 suitable for retaining a flat output cable 106B in combination with a cable stay as will be described herein. The example wedge 940 includes a body 941 having a base 942. A first side of the base 942 is bent to form a first side wall 943 and a second side of the base 942 is bent to form a second side wall 944. A top of the base 942 also is bent to form a top 945. Each side wall 943, 944 defines a tapered surface 946 distal of the base 942.

FIG. 75 illustrates a flat output cable 106B being mounted to the example cable manager 900. A cable stay 930 is arranged in one of the receiving channels 917 defined by a pair of adjacent arms 915. The reduced width section 934 of the cable stay 930 extends through the receiving channel 917 and the ends 932, 933 of the cable stay 930 seat on either side 903, 905 of the second arms 915. In accordance with one aspect, the cable stay 930 is inserted through the reduced section 921 of the receiving channel 917 diagonally and turned to press flat against the ends of the first arms 911. The flat output cable 106B is routed through the receiving channel 917 and pressed against the cable stay 930. The catches 935 of the cable stay 930 are shaped and configured to facilitate routing the output cable 106B in a first direction and to inhibit cable pullout in an opposite direction.

A wedge 940 is inserted into the receiving channel 917 between the flat output cable 106B and the flanges 919 to secure the cable 106B to the manager 900. In the example shown in FIG. 61, the side walls 943, 944 of the wedge 940 fit into adjacent notches 922 defined by the adjacent flanges 919. The top 945 of the wedge 940 can seat on top of the flanges, covering the reduced width portion 921 of the receiving channel 917. Because the side walls 943, 944 of the wedge are tapered, the wedge 940 is oriented at an angle with respect to the cable stay 930. Accordingly, inserting the wedge 940 into the receiving channel 917 presses the output cable 106B into the cable stay 930.

As shown in FIGS. 66 and 75, a cable seal also can be provided at the cable output port 315. In accordance with some aspects, the cable seal cooperates with the cable manager 900 to inhibit ingress of contaminants from outside the FDH 300. For example, in accordance with one aspect, the cable manager 900 can seat on the seal at the output port 315.

FIGS. 76-78 show an example cable seal 950 suitable for use with the example cable manager 900. The cable seal 950 includes a generally disc-shaped body 951 defining a plurality of cable channels extending through the body 951. In accordance with some aspects, the body 951 defines cable channels for round cables and cable channels for flat cables. In the example shown in FIG. 78, the body 951 defines an a first set of cable channels 952 for round cables, a second set of cable channels 954 for round cables, and a third set of cable channels 956 for flat cables. The cable channels are connected by slits 955.

FIG. 79 is a top, front perspective view of an example FDH in which a cover has been pivoted upwardly to an open position, a pass-through frame has been pivoted laterally outwardly in a first direction, and a swing frame has been pivoted laterally outwardly in a second direction. FIG. 80 is a top, front perspective view of the example FDH shown in FIG. 79 in which the back of the swing frame is visible.

FIG. 81 is a top, front perspective view of an example swing frame suitable for mounting in any of the above-described FDHs. A splitter bay containing four splitter modules is mounted to the example swing frame. Termination modules and storage modules also have been mounted to the swing frame. FIG. 82 is a top, rear perspective view of the example swing frame of FIG. 81. Six fanouts are shown mounted to the back of the swing frame. Cable routing structures, such as bend radius limiters and spools are shown mounted to the swing frame for routing cables along the swing frame.

FIGS. 83-86 illustrate another example implementation of an FDH cabinet 1200 including another example implementation of a cable manager 1000. The FDH cabinet 1200 includes a base 1210 having a back wall 1211 defining mounting openings through which a fastener can be inserted to secure the base 1210 to a mounting surface (e.g., a wall, a panel, a tree, etc.). The base 1210 includes a bottom wall 1213 that defines at least one entrance/exit port. In accordance with some aspects, the bottom wall 1213 defines one or more feeder cable ports 1214. In accordance with other aspects, the bottom wall 1213 also defines one or more output cable ports 1215. In accordance with still other aspects, the bottom wall 1213 also can define one or more stub cable ports 1216. In accordance with still other aspects, the bottom wall 1213 can define additional cable ports 1218 at which one or more feeder cables and/or distribution cables can be retained. For example, the additional cable ports 1218 can receive fiber cables associated with a different provider than the other cables routed into the cabinet 1200.

In some implementations, a pass-through frame 1260 and a swing frame, such as swing frame 400, can be mounted to the base 1210 (or a support frame mounted thereto). A securement device 1270 and cable management structures can be mounted to the pass-through frame 1260. In one implementation, the securement device 1270 is the same as securement device 370 discussed above.

In accordance with certain aspects, a pass-through type feeder cable 104 can pass through a sealing member 1279 when entering the FDH 1200. The sealing member 1279 fits within the feeder cable port 1214. In some implementations, the sealing member 1279 defines two openings each connected to an exterior surface of the sealing member 1279 by a slit through which the cables can pass. In accordance with one aspect, the incoming portion of the feeder cable 104A can pass through one opening and the outgoing portion of the feeder cable 104B can pass through the other opening.

In accordance with some aspects, the pass-through frame 1260 can be pivotally coupled to the base 1210 (e.g., via a support frame). In accordance with certain aspects, the pass-through frame 1260 can be pivoted through a limited range to facilitate access to the telecommunications components mounted within the FDH 1200. For example, in accordance with one aspect, the pass-through frame 1260 can be pivoted from a first position in which the securement device 1270 and sealing member 1279 align with the feeder cable port 1214 (see FIG. 83) to a second position providing enhanced access to the back corners of the FDH base 1210.

One or more output fibers 210 enter the FDH 1200 at the output cable port 1215 and extend to the interface device at which the output fibers 210 can be optically coupled to the subscriber lines 208. In accordance with some embodiments, the output fibers 210 can be separated from the cable jackets and strength members of the respective output cables 106 at a cable manager 1000 that is provided at the cable port 1215 (e.g., see FIG. 83). In accordance with certain aspects, the cable manager 1000 secures the output cables 106 to the FDH 1200.

FIG. 84 illustrates one example cable manager 1000 suitable for use with the FDH 1200. The cable manager 1000 includes a body 1001 having a first (e.g., top) side and an opposite second (e.g., bottom) side. In the example shown, the body 1001 of the cable manager 1000 generally defines a rectangular shape. In some implementations, the body 1001 seats on the bottom wall 1213 of the cabinet 1200 above an opening or slot. In certain implementations, the manger body 1001 seats on a ledge 1252 defined by the cabinet bottom wall 1213 (see FIGS. 83 and 84).

In certain implementations, the body 1001 includes at least one ledge or flange 1021 via which the body 1001 can be secured to the FDH cabinet 1200. For example, the ledge or ledges 1021 of the cable manager 1000 can be retained beneath one or more curved or bent flange 1221 extending upwardly from the bottom wall 1213 of the cabinet 1200 (see FIG. 84). In the example shown, the ledge 1021 is provided at the second side of the body 1001. In other implementations, however, the body 1001 can be secured from the first side or from an intermediate flange.

In accordance with some aspects, the cable manager 1000 is configured to receive multiple types of output cables 106. In accordance with one aspect, the cable manager 1000 can be configured to receive round output cables 106A and flat output cables 106B. For example, the body 1001 of the cable manager 1000 can define openings 1003 configured to accommodate fibers of round output cables 106A and openings 1004 configured to accommodate fibers of flat output cables 106B. In the example shown in FIG. 84, the cable manager 1000 is configured to receive up to sixteen round cables and up to eight flat cables. In accordance with other aspects, however, the cable manager 1000 can be configured to receive any desired type of cable.

A cable seal or gasket 1050 is mounted to the bottom wall 1213 adjacent the manger 1000. In some implementations, the gasket 1050 includes a body 1051 defining a plurality of passages through which the output cables 106 can be routed. In certain implementations, the gasket 1050 is configured to receive multiple types of output cables 106. For example, the gasket 1050 can define a first set of passages 1052 configured to receive round output cables 106A and a second set of passages 1054 configured to receive flat output cables 106B (see FIG. 86).

The gasket body 1051 is mounted to the bottom wall 1213 of the cabinet 1200 beneath the manger body 1001. In some implementations, the gasket body 1051 is mounted within a channel 1253 defined in the bottom wall 1213. For example, the bottom walls 1213 can define a channel 1253 define by a first ledge 1251 located at an exterior of the cabinet 1200 and a second ledge 1252 located at an interior of the cabinet 1200. The gasket body 1051 can slide into the channel 1253 and be retained between the first and second ledges 1251, 1252.

In one implementation, the gasket 1050 has a thin layer of material overlaying the tops of each passage 1052, 1054. The thin layer inhibits ingress of dirt, water, rodents or other contaminants into the cabinet 1200 via the passage. When a cable 106 is installed at the cable port 1215, the cable 106 is forced through the layer of material to create the through passage through the gasket body 1051. In the example shown, the gasket body 1051 defines multiple partial cavities for manufacturing purposes (FIG. 86). The partial cavities do not pass completely through the gasket body 1051.

Referring back to FIG. 84, the manager body 1001 defines at least one slot 1012 extending through the body 1001 from the first side to the second side. The slot 1012 is configured to enable fibers 210 of at least one output cable 106 to pass through the body 1001. In some implementations, each slot 1012 can receive multiple output cables 106. Typically, the cable manager 1000 includes multiple slots 1012 through which the output fibers 210 can pass.

In the example shown, the manger body 1001 defines a plurality of slots 1012 extending inwardly from sides (e.g., front and back) of the manager body 1001 to define a plurality of sections of the manger body 1001. Each slot 1012 defines at least one enlarged section forming an opening 1004 sized and configured to accommodate the passage of fibers of a flat cable 106B. In accordance with some implementations, each slot 1012 also defines at least one additional enlarged section forming an opening 1003 sized and configured to accommodate the passage of fibers of a round cable 106A. In the example shown, each slot 1012 defines two such round cable openings 1003 spaced along a length of the slot 1012. In certain implementations, the openings 1003 are located farther inwardly from the sides of the body 1001 than the openings 1004.

The manger body 1001 is configured to receive one or more strength member tie-downs 1006 at which strength members (e.g., aramid yarn) of the output cables 106 can be secured. For example, the manger body 1001 can define multiple openings configured to receive tie-down fasteners (e.g., screws). In some implementations, the tie-downs 1006 are positioned in rows between the slots 1012. In the example shown, a strength member tie-down 1006 is provided for each round cable opening 1003. In use, strength members of the round output cables 106 can be wrapped around and secured by a fastener mounted at one of the tie-downs 1006.

In accordance with certain embodiments, the enlarged sections 1004 define receiving channels that are configured to accommodate retention members. The retention members are configured to aid in the securement of flat output cables 106B to the cable manager 1000. For example, each receiving channel 1004 can be configured to accommodate a cable stay_and a wedge 940 (e.g., see FIG. 84). One example stay 930 suitable for use with cable manager 1000 is shown in FIGS. 69 and 70 and discussed above. One example wedge 940 suitable for use with cable manager 1000 is shown in FIGS. 71-74 and discussed above.

In the example shown, the enlarged section 1014 of each slot 1012 extends outwardly from shoulders 1018 defined by adjacent sections of the manger body 1001 to flanges 1019 (FIG. 84). The shoulders 1018 are configured to accommodate the cable stays 930 and the flanges 1019 are configured to accommodate the wedges 940. In some implementations, each pair of adjacent flanges 1019 defines a reduced width section of the receiving channel 1004. Each flange 1019 also bends back toward the body 1001 to define a notch to aid in retaining the wedge 940.

Referring to FIG. 85, additional cables can be routed into the cabinet 1200 through the additional cable port 1218. In the example shown, the cable port 1218 defines four cable openings 1219. In one implementation, a second feeder cable can be routed into and out of the cabinet 1200 through two of the openings 1219, similar to how the first feeder cable 104 is routed into the cabinet 1200 at the first feeder cable port 1214. Slack fibers of the second feeder cable 104 can be stored within the cabinet 1200. For example, the slack fibers can be stored by wrapping the fibers around cable manager structures positioned on the back wall of the cabinet 1200. In one implementation, the cable management structures can be arranged on the back wall similar to management structures 1100 in FIG. 80.

In some implementations, first and second support members 1232, 1234 can be mounted at the cable port 1218 to define the cable openings 1219 (see FIG. 85). For example, the first cable support 1232 can be slid into the cable port 1218 from the front of the cabinet 1200. The first cable support 1232 can cooperate with the bottom wall 1213 of the cabinet 1200 to define a first set of cable openings 1219. In the example shown, the first cable support 1232 cooperates with the bottom wall 1213 to define a pair of cable openings 1219. The second cable support 1234 can be slid into the cable port 1218 from the front of the cabinet 1200. The second cable support 1234 can cooperate with the first cable support 1232 to define a second set of cable openings 1219. In the example shown, the second cable support 1234 cooperates with the first cable support 1232 to define a second pair of cable openings 1219. In some implementations, the cable support members 1232 are removeably fastened to the cabinet bottom wall 1213 using screws or other such fasteners.

In certain implementations, each cable support 1232, 1234 includes walls or other support structures 1235 extending upwardly into the cabinet 1200 (see FIG. 83). The walls 1235 aid in retaining the cables held at the cable port 1218. Cable securement devices, such as fastening screws, can be mounted within the cabinet 1200 at the cable port 1218 to retain strength members of the cables passing through the cable port 1218. In certain implementations, the cable securement devices can be mounted to the walls 1235. In other implementations, however, the cable securement devices can be mounted to the cabinet bottom wall 1213 or to other portions of the cable support members 1232, 1234.

The above specification, examples and data provide a complete description of the manufacture and use of the composition of the invention. Since many embodiments of the invention can be made without departing from the spirit and scope of the invention, the invention resides in the claims hereinafter appended.

1. A fiber distribution hub comprising:
a cabinet including a wall defining an opening;
an insert positioned in the opening, the insert defining first and second ports;
a panel positioned within the cabinet, the panel being pivotally movable relative to the wall;
a cable anchor positioned on the panel;
a pass-through cable routed through the first and second ports, the pass-through cable having a loop portion that extends within the cabinet from the first port to the second port, the loop portion being managed by cable management structures on the panel, the pass-through cable being anchored to the panel at the cable anchoring location;
wherein the loop portion of the pass-through cable is carried by the panel when the panel is pivoted.

2. The fiber distribution hub of claim 1, wherein a termination region is positioned within the cabinet, the termination region including a plurality of connector adapters.

3. The fiber distribution hub of claim 1, wherein the termination region is provided on a swing frame mounted within the cabinet, the swing frame being configured to pivot separately from the panel.

4. The fiber distribution hub of claim 3, wherein the cabinet includes a generally vertically extending support frame mounted to the wall, wherein the swing frame is mounted to the support frame.

5. The fiber distribution hub of claim 4, wherein a stack of splice trays is positioned on the support frame, each splice tray of the stack including a base defining an open top and including a splice mounting location on the base configured to receive optical fiber splices, wherein each splice tray of the stack is pivotally moveable relative to the support frame between a first position and a second position.

6. The fiber distribution hub of claim 5, wherein the open top of each splice tray faces the support frame when the splice tray is in the first position and wherein the splice mounting location is accessible through the open top when the splice tray is in the second position.

7. The fiber distribution hub of claim 1, wherein the cable anchor is located adjacent the insert.

8. The fiber distribution hub of claim 1, wherein the wall is a bottom wall of the cabinet.

9. The fiber distribution hub of claim 1, further comprising a cable manager positioned within the cabinet at a location spaced from the opening, the cable manager defining a first set of slots and a second set of slots, the first set of slots being configured to receive round distribution cables and the second set of slots being configured to receive flat distribution cables.

10. A fiber distribution hub comprising:
a cabinet including a upright wall;
a splice tray stack mounted to the upright wall, the splice tray stack including a plurality of splice trays, each splice tray including a base, an open top, and a splice mounting location on the base;
wherein each splice tray is pivotally moveable relative to the upright wall between a first position and a second position;
wherein the open top of each splice tray faces the upright wall when the splice tray is in the first position, thereby inhibiting access to the splice mounting location; and
wherein the splice mounting location of each splice tray is accessible through the open top when the splice tray is in the second position.

11. The fiber distribution hub of claim 10, wherein each splice tray includes a cover that is pivotally mounted to the base to close the open top of the splice tray.

12. The fiber distribution hub of claim 10, wherein the splice trays are configured to move together as a stack between the first and second positions, wherein a retaining member on the upright wall holds the splice tray stack in the first position, and wherein the splice trays also are each configured to move independently between the first and second positions.

13. The fiber distribution hub of claim 10, further comprising:
a panel pivotally mounted to the upright wall;
an insert mounted within the cabinet, the insert defining first and second cable ports;
a cable anchor location positioned on the panel adjacent the insert;
a pass-through cable routed through the first and second ports, the pass-through cable having a loop portion that extends within the cabinet from the first port to the second port, the loop portion being managed by spool structures on the panel, the pass-through cable being anchored to the panel at the cable anchoring location;
wherein the cable anchor, the loop portion of the pass-through cable, and the insert pivot with the panel relative to the wall when the panel is pivoted.

14. The fiber distribution hub of claim 10, further comprising a cable manager positioned within the cabinet, the cable manager defining a first set of slots and a second set of slots, the first set of slots being configured to receive round distribution cables and the second set of slots being configured to receive flat distribution cables.

15. A fiber distribution hub comprising:
a cabinet including a feeder cable port, a distribution cable port, a splitter location at which at least one splitter module is mounted, and a termination region at which a plurality of adapters are mounted;
a feeder cable routed into the cabinet at the feeder cable port, the feeder cable including at least a first optical fiber that is optically coupled to the splitter module;
a plurality of distribution cables routed out of the cabinet at the distribution cable port, each distribution cable including at least one optical fiber that is optically coupled to a connector plugged into one of the adapters at the termination region;
a plurality of pigtails routed from the splitter module to the termination region, each pigtail having a connectorized end that plugs into one of the adapters at the termination region to create an optical path between the pigtail and the optical fiber of one of the distribution cables; and
a cable manager positioned within the cabinet at the distribution cable port, the cable manager defining a first set of slots and a second set of slots, the first set of slots being configured to receive round distribution cables and the second set of slots being configured to receive flat distribution cables.

16. The fiber distribution hub of claim 15, wherein the first set of slots are located at an inner portion of the cable manager and the second set of slots are located at an outer portion of the cable manager.

17. The fiber distribution hub of claim 15, wherein the cabinet includes an upright wall having a splice location at which at least one splice tray is mounted, the first optical fiber of the feeder cable being routed to the splice tray, the first optical fiber of the feeder cable being spliced to a splitter input fiber at the splice tray, the splitter input fiber being routed to the splitter module to optically couple the first optical fiber to the splitter module.

18. The fiber distribution hub of claim 17, wherein the splice tray includes a base tray and a cover, wherein the splice tray is configured to move between an inaccessible position and an accessible position, and wherein the cover of the splice tray faces the upright wall when the splice tray is in an inaccessible position and wherein the base tray is oriented generally horizontal when the splice tray is in the accessible position.

19. The fiber distribution hub of claim 15, wherein the cable manager includes a plurality of tie-downs configured to receive strength members of the round distribution cables; and wherein the cable manager includes a plurality of cable stays and a plurality of wedges, each cable stay including a body configured to mount within one of the slots of the second set of slots, the body of each cable stay being generally flat and defining catches that are configured to dig into a jacket of the output cable received at the respective slot; and each wedge including a body configured to mount within one of the slots of the second set of slots, the body of each wedges including a ramped surface configured to press the output cable received at the respective slot against the respective cable stay.

20. The fiber distribution hub of claim 16, further comprising:
a panel positioned within the cabinet, the panel being pivotally movable relative to the upright wall;
an insert positioned at the feeder cable port, the feeder cable being routed into the cabinet through the insert;
a cable anchor location positioned on the panel adjacent the insert;
a cable anchor mounted to the cable anchor location on the panel, wherein the feeder cable is secured to the cable anchor;
wherein the feeder cable has a loop portion that extends within the cabinet from the insert, around a set of spool structures, and back to the insert;
wherein the cable anchor, the loop portion of the feeder cable, and the insert pivot with the panel relative to the upright wall when the panel is pivoted.

21. The fiber distribution hub of claim 1, wherein the cable anchor and the insert pivot with the panel relative to the wall when the panel is pivoted.
